(19) United States
(12) Patent Application Publication
(10) Pub. No.: US 2017/0075737 A1
(43) Pub. Date: Mar. 16, 2017

(54) METHOD OF DISPLAYING NOTIFICATIONS AND ELECTRONIC DEVICE ADAPTED THERETO

(71) Applicant: Samsung Electronics Co., Ltd., Gyeonggi-do (KR)

(72) Inventors: Youngri KIM, Gyeonggi-do (KR); Jina LEE, Seoul (KR); Eunsun KIM, Seoul (KR); Kwangha JEON, Gyeonggi-do (KR); Minhwa HONG, Seoul (KR); Yoojin HONG, Gyeonggi-do (KR); Jeonghyun PANG, Gyeonggi-do (KR)

(21) Appl. No.: 15/267,916

(22) Filed: Sep. 16, 2016

(30) Foreign Application Priority Data
Sep. 16, 2015 (KR) 10-2015-0131190

(51) Int. Cl. G06F 9/54; G06F 3/0484; H04B 1/3827; H04L 29/08; H04L 12/58

(52) U.S. Cl. CPC G06F 9/542; H04L 67/26; H04L 51/12; H04L 67/306; H04B 1/3827; G06F 3/0484; H04L 51/04; H04L 51/32; H04W 4/14

(57) ABSTRACT

A method of displaying notifications and an electronic device adapted thereto are provided. The method includes receiving at least one communication event or message from at least one external device; obtaining identification information which is stored in the memory or is obtained from the at least one external device or at least one external device; identifying a user who sent the received, at least one communication event or message, by using the obtained identification information; creating or extracting notice information, based on at least part of the received, at least one communication event or message; linking the notice information to the identified user; and displaying and overlaying a notice, grouping information regarding the identified user and the notice information, on other objects displayed on the screen of the display.

### PRIORITY

This application claims priority under 35 U.S.C. §119(a) to Korean Patent Application No. 10-2015-0131190 filed in the Korean Intellectual Property Office on Sep. 16, 2015, the entire disclosure of which is incorporated herein by reference.

### BACKGROUND

1. Field of the Disclosure

The present disclosure relates generally to displaying notifications, and more particularly, to a method of displaying notifications on a screen and an electronic device adapted to the method.

2. Description of Related Art

Certain electronic devices have been implemented to integrally support various user functions, such as taking images, playing back multimedia, games, receiving broadcasts, etc. With the variety of functions implemented by such electronic devices, these electronic devices are capable of providing a notification service for displaying a presence of a specified event on the screen. For example, when a text message arrives or a missed call occurs with respect to an electronic device, the electronic device is capable of displaying notifications related to the missed call and the arrival of the text message on a screen of the electronic device. In particular, as social network service/site (SNS) activity has become popular, electronic devices have become capable of providing notification services based on SNS-related applications. For example, when an electronic device receives messages based on SNS-related applications, the electronic device identifies the received messages based on the SNS-related applications, and provides a notification service for the received messages.

Electronic devices are capable of providing a notification service based on applications installed to the memory of the electronic devices. For example, when an electronic device receives a specified notification (e.g., an arrival of a message, a communication event, etc.) via an application such as Facebook, for example, the electronic device is capable of displaying the number of received Facebook application-based notifications on the screen of the electronic device. That is, the electronic device is capable of providing a notification service that notifies whether a notification event is received based on an application. For example, when notifications regarding a ‘message reception’ and a ‘missed call’ from the same sender occur, the electronic device is capable of displaying the two occurrence notifications on the screen. When notification events from the same sender occur on the electronic device, via different applications installed in the electronic device, the electronic device is capable of providing the notifications based on the respective applications.

### SUMMARY

An aspect of the present disclosure is to address the above problems and disadvantages, and to provide at least the advantages described below. Accordingly, embodiments of the present disclosure provide a method of displaying notifications that occur in an electronic device, based on senders who sent notification events, and the electronic device adapted to the method.

In accordance with an aspect of the present disclosure, an electronic device is provided. The electronic device includes a communication circuit; a display; a processor electrically connected to the communication circuit and the display; and a memory electrically connected to the processor. The memory stores instructions enabling the processor to receive at least one communication event or message from at least one external device, via the communication circuit; identify a user who sent the received, at least one communication event or message, by using identification information which is stored in the memory or is obtained from the at least one external device or at least one other external device; create or extract notice information, based on at least part of the received, at least one communication event or message; link the notice information to the identified user; and display and overlay a notice, grouping information regarding the identified user and the notice information, on other objects displayed on the screen of the display.

In accordance with another aspect of the present disclosure, a method of displaying notifications is provided. The method includes receiving at least one communication event and message from at least one external device; obtaining identification information which is stored in a memory or is obtained from the at least one external device or at least one other external device; identifying a user who sent the received, at least one communication event or message, by using the obtained identification information; creating or extracting notice information, based on at least part of the received, at least one communication event or message; linking the notice information to the identified user; and display and overlaying a notice, grouping information regarding the identified user and the notice information, on other objects displayed on the screen of the display.

### BRIEF DESCRIPTION OF THE DRAWINGS

The above and other aspects, features and advantages of the present disclosure will be more apparent from the following detailed description, taken in conjunction with the accompanying drawings, in which:

FIG. 1 is a diagram illustrating a network environment including an electronic device according to an embodiment of the present disclosure;

FIG. 2 is a block diagram illustrating an electronic device according to an embodiment of the present disclosure;

FIG. 3 is a block diagram illustrating a program module according to an embodiment of the present disclosure;

FIG. 4 is a diagram that illustrates a method of switching an application-based notification management mode to a user-based notification management mode according to an embodiment of the present disclosure;

FIG. 5 is a block diagram illustrating a detailed configuration of the electronic device according to an embodiment of the present disclosure;

FIG. 6 is a block diagram that illustrates a case when the electronic device processes an identification key corresponding to a sender related to a communication event according to an embodiment of the present disclosure;

FIG. 7 is a diagram that illustrates the creation of a notification list DB by the electronic device according to an embodiment of the present disclosure;

FIGS. 8A and 8B are flow diagrams that illustrate a method of managing senders and displaying notifications according to an embodiment of the present disclosure;

FIG. 9 is a flowchart that illustrates a method for an electronic device to display notifications based on senders related to communication events that occur in the electronic device according to an embodiment of the present disclosure;

FIG. 10 is a flowchart that illustrates a method for an electronic device to display notifications, based on individuals or groups, according to an embodiment of the present disclosure;

FIGS. 11A and 11B are diagrams illustrating a method of setting view settings for notifications based on individuals or groups according to an embodiment of the present disclosure;

FIGS. 11C and 11D are diagrams that illustrate a method of displaying notifications according to an embodiment of the present disclosure;

FIG. 12 is a diagram that describes a method of setting view settings for notifications according to sender-based applications, according to an embodiment of the present disclosure;

FIG. 13 is a diagram that illustrates a method of setting view settings for notifications of senders, considering a context of the receiver, according to an embodiment of the present disclosure;

FIG. 14 is a diagram that illustrates a method of setting view settings for notifications of senders, according to the user's owned electronic devices, according to an embodiment of the present disclosure;

FIG. 15 is a diagram that illustrates a method of displaying notifications in a lock screen state, based on senders, according to an embodiment of the present disclosure;

FIG. 16 is a diagram that illustrates a method of displaying notifications on the QuickPanel, based on senders, according to an embodiment of the present disclosure;

FIG. 17 is a diagram that illustrates a method of displaying senders that belong to the same group, in same color, on the QuickPanel, according to an embodiment of the present disclosure;

FIGS. 18A and 18B are diagrams illustrating a notification displayed via the indicator according to an embodiment of the present disclosure;

FIGS. 19A to 19D are diagrams illustrating wearable electronic devices displaying notifications according to an embodiment of the present disclosure;

FIG. 20A is a diagram that illustrates a method of creating icons and folders, based on senders, on the home screen according to an embodiment of the present disclosure;

FIG. 20B is a diagram that illustrates a method of displaying notifications based on individuals when a sender icon is selected on the home screen according to an embodiment of the present disclosure;

FIG. 20C is a diagram that illustrates a method of displaying notifications based on groups when a sender folder is selected on the home screen according to an embodiment of the present disclosure;

FIG. 21 is a diagram that illustrates a method of displaying notifications via a widget according to an embodiment of the present disclosure; and

FIG. 22 is a diagram that illustrates a method of displaying, when searching for a sender, the view settings and notifications based on the sender.

### DETAILED DESCRIPTION OF EMBODIMENTS OF THE DISCLOSURE

Hereinafter, embodiments of the present disclosure are described with reference to the accompanying drawings. Although specific embodiments are illustrated in the drawings and related details are described herein, embodiments of the present disclosure may be modified in various ways. However, embodiments of the present disclosure are not limited to a specific implementation form, and it should be understood that the present disclosure includes all changes and/or equivalents and substitutes included in the spirit and scope of embodiments of the present disclosure. In the drawings and their corresponding descriptions, the same or similar components may be designated by the same or similar reference numerals.

Herein, the terms such as “include”, “have”, “may include” and “may have” may be construed to denote a certain characteristic, number, step, operation, constituent element, component or a combination thereof, but are not to be construed to exclude the existence of or a possibility of addition of one or more other characteristics, numbers, steps, operations, constituent elements, components or combinations thereof.

Herein, the expressions “or” or “at least one of A and/or B” includes any or all of combinations of words listed together. For example, the expression “A or B” or “at least A and/or B” may include A, may include B, or may include both A and B.

The expressions “1”, “2”, “first”, and “second”, as used herein, may modify components of the embodiments but does not limit the corresponding components. For example, the above expressions do not limit the sequence and/or importance of the components. The expressions may be used to distinguish a component from other components. For example, the terms “a first user device” and “a second user device” indicate different user devices although both of them are user devices. For example, without departing from the scope of the present disclosure, a first structural element may be referred to as a second structural element. Similarly, the second structural element also may be referred to as the first structural element.

When it is stated that a component is “(operatively or communicatively) coupled to” or “connected to” another component, the component may be directly coupled or connected to the other component, or a new component may exist between the component and the other component. By contrast, when it is stated that a component is “directly coupled to” or “directly connected to” another component, a new component does not exist between the component and the other component. In the present disclosure, the expression “configured (or set) to do” may be used interchangeably with, for example, “suitable for doing,” “having the capacity to do,” “designed to do,” “adapted to do,” “made to do,” or “capable of doing.” The expression “configured (or set) to do” is not necessarily used to refer to only something in hardware for which it is “specifically designed to do.” Instead, the expression “a device configured to do” may indicate that the device is “capable of doing” something with other devices or parts. For example, the expression “a processor configured (or set) to do A, B and C” may refer to a dedicated processor (e.g., an embedded processor) or a generic-purpose processor (e.g., CPU or application processor) that may execute one or more software programs stored in a memory device to perform corresponding functions.

An electronic device according to embodiments of the present disclosure may be a device including an antenna. For example, the electronic device may be one or more of a smart phone, a tablet personal computer (PC), a mobile phone, a video phone, an e-book reader, a desktop PC, a laptop PC, a netbook computer, a personal digital assistant (PDA), portable multimedia player (PMP), a motion picture experts group (MPEG) audio-layer 3 (MP3) player, a mobile medical application, a camera, and a wearable device (e.g., a head-mounted-device (HMD), such as electronic glasses, electronic clothes, an electronic bracelet, an electronic necklace, an electronic appcessary, an electronic tattoo, and a smart watch).

According to some embodiments of the present disclosure, the electronic device may be a smart home appliance having an antenna. The smart home appliance may include at least one of a television (TV), a digital video disk (DVD) player, an audio player, an air conditioner, a cleaner, an oven, a microwave oven, a washing machine, an air purifier, a set-top box, a TV box (for example, Samsung HomeSync™, Apple TV™, or Google TV™), game consoles, an electronic dictionary, an electronic key, a camcorder, and an electronic frame.

According to some embodiments of the present disclosure, the electronic device may include at least one of various types of medical devices (e.g., magnetic resonance angiography (MRA), magnetic resonance imaging (MRI), computed tomography (CT), a scanner, an ultrasonic device and the like), a navigation device, a global positioning system (GPS) receiver, an event data recorder (EDR), a flight data recorder (FDR), a vehicle infotainment device, electronic equipment for a ship (e.g., a navigation device for ship, a gyro compass and the like), avionics, a security device, a head unit for a vehicle, an industrial or home robot, an automatic teller machine (ATM) of financial institutions, and a point of sale (POS) device of shops.

According to some embodiments of the present disclosure, the electronic device may include at least one of furniture or a part of a building/structure, an electronic board, an electronic signature receiving device, a projector, and various types of measuring devices (for example, a water meter, an electricity meter, a gas meter, a radio wave meter and the like), which are equipped with an antenna. The electronic device according to embodiments of the present disclosure may also be a combination of the devices listed above. Further, the electronic device according to embodiments of the present disclosure may be a flexible device. It will be apparent to those skilled in the art that the electronic device according to embodiments of the present disclosure is not limited to the above described devices.

Hereinafter, electronic devices according to embodiments of the present disclosure will be discussed with reference to the accompanying drawings. The term se skilled in the art that the electronic device according to embodiments of the present disclosure and the e (e.g., an artificial intelligence electronic device) using an electronic device.

Herein, the term “notification event” may refer to an event to provide a notification service. For example, when a text message arrives in an electronic device, the electronic device is capable of providing a notification service informing the user that a text message has arrived. In addition, the expression “notification event including a message” may refer to a text message.

According to embodiments of the present disclosure, the expression “to provide a notification service” may be used to refer to situations such as when an electronic device displays a notification regarding a ‘notification event.’ When an event (e.g., arrival of a text message, presence of a missed call) occurs in the electronic device, the electronic device is capable of displaying a notification informing the user of the occurrence of the event. The expression “to provide a notification service” may also be used to refer to situations such as when an electronic device displays a notification window corresponding to a ‘notification event’ or outputs an audio event.

In embodiments of the present disclosure, the term “communication application” may refer to an application that performs communication via a network, such as Facebook, KakaoTalk, Skype, etc. In addition, the term “communication application” may also refer to an application capable of providing a service that allows a sender and a receiver to transmit/receive messages to/from each other.

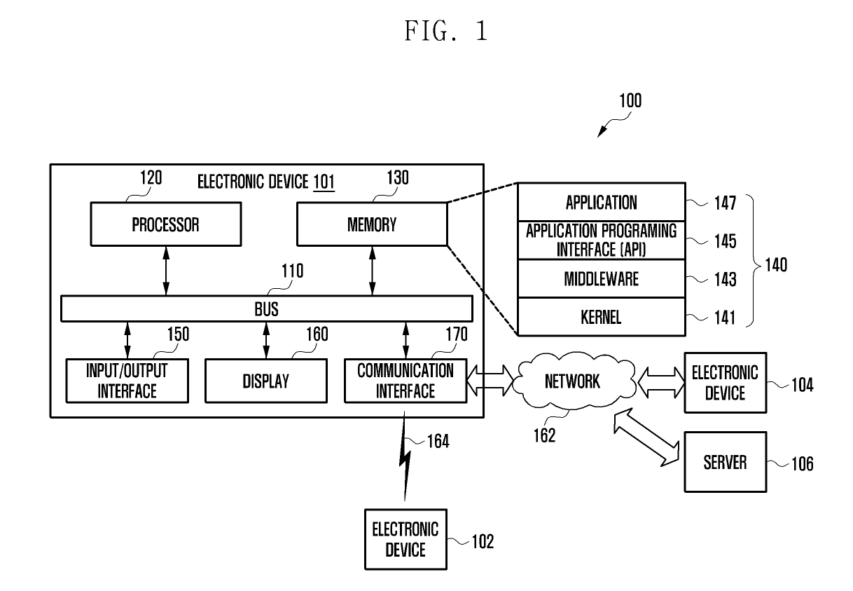

FIG. 1 illustrates a network environment including an electronic device according to an embodiment of the present disclosure.

Referring to FIG. 1, a network environment 100 includes an electronic device 101, which includes a bus 110, a processor 120, a memory 130, an input/output interface 150, a display 160, and a communication interface 170. According to some embodiments of the present disclosure, at least one of the above described components may be omitted from the electronic device 101 or another component may be further included in the electronic device 101.

The bus 110 may be a circuit connecting the above-described components 120, 130, 150, 160, and 170 and transmitting communications (e.g., control messages and/or data) between the above-described components.

The processor 120 may include one or more of a central processing unit (CPU), an application processor (AP), and a communication processor (CP). The processor 120 is capable of controlling at least one of other components of the electronic device 101 and/or processing data or operations related to communication.

The memory 130 may include volatile memory and/or non-volatile memory. The memory 130 is capable of storing data or commands related to at least one of other components of the electronic device 101. According to an embodiment, the memory 130 is capable of storing software and/or a program module 140. For example, the program module 140 includes a kernel 141, middleware 143, application programming interface (API) 145, application programs (or applications) 147, etc. The kernel 141, middleware 143 or at least part of the API 145 may be referred to as an operating system (OS).

The kernel 141 is capable of controlling or managing system resources (e.g., the bus 110, processor 120, memory 130, etc.) used to execute operations or functions of other programs (e.g., the middleware 143, API 145, and application programs 147). The kernel 141 provides an interface capable of allowing the middleware 143, API 145, and application programs 147 to access and control/manage the individual components of the electronic device 101.

The middleware 143 is capable of mediating between the API 145 or application programs 147 and the kernel 141 so that the API 145 or the application programs 147 can communicate with the kernel 141 and exchange data therewith. The middleware 143 is capable of processing one or more task requests received from the application programs 147 according to the priority. For example, the middleware 143 is capable of assigning a priority for use of system resources of the electronic device 101 (e.g., the bus 110, processor 120, memory 130, etc.) to at least one of the application programs 147. For example, the middleware 143 processes one or more task requests according to a priority assigned to at least one of the application programs 147, thereby performing scheduling or load balancing for the task requests.

The API 145 is an interface configured to allow the application programs 147 to control functions provided by the kernel 141 or the middleware 143. The API 145 is capable of including at least one interface or function (e.g., instructions) for file control, window control, image process, text control, or the like.

The input/output interface 150 is capable of transferring instructions or data, received from the user or external devices, to one or more components of the electronic device 101. The input/output interface 150 is capable of outputting instructions or data, received from one or more components of the electronic device 101, to the user or external devices.

The display 160 is capable of including, for example, a liquid crystal display (LCD), a flexible display, a transparent display, a light emitting diode (LED) display, an organic light emitting diode (OLED) display, a micro-electro-mechanical systems (MEMS) display, an electronic paper display, etc. The display 160 is capable of displaying various types of content (e.g., texts, images, videos, icons, symbols, etc.). The display 160 may also be implemented with a touch screen that is capable of receiving touches, gestures, proximity inputs or hovering inputs, via a stylus pen, or a user's body.

The communication interface 170 is capable of establishing communication between the electronic device 101 and an external device (e.g., a first external device 102, a second electronic device 104, or a server 106). For example, the communication interface 170 is capable of communicating with an external device (e.g., a second external device 104 or a server 106) connected to the network 162 via wired or wireless communication.

Wireless communication may employ, as a cellular communication protocol, at least one of long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM). Wireless communication may also include short-wireless communication 164. Short-wireless communication 164 may include at least one of wireless fidelity (WiFi), Bluetooth (BT), near field communication (NFC), magnetic secure transmission (MST), and global navigation satellite system (GNSS). The GNSS may include at least one global positioning system (GPS), global navigation satellite system (Glonass), Beidou navigation satellite system (Beidou), and Galileo, the European global satellite-based navigation system, according to GNSS using areas, bandwidths, etc. In the present disclosure, “GPS” and “GNSS” may be used interchangeably. Wired communication may include at least one universal serial bus (USB), high definition multimedia interface (HDMI), recommended standard 232 (RS-232), and plain old telephone service (POTS). The network 162 may include at least one of a telecommunications network, e.g., a computer network (e.g., LAN or WAN), the Internet, and a telephone network.

The first and second external electronic devices 102 and 104 may each be identical to or different from the electronic device 101, in terms of type of device. According to an embodiment of the present disclosure, the server 106 is capable of including a group of one or more servers. A part or all of the operations executed on the electronic device 101 may be executed on another electronic device or a plurality of other electronic devices (e.g., electronic devices 102 and 104 or a server 106). When the electronic device needs to perform a function or service automatically or according to a request, it does not perform the function or service, but is capable of additionally requesting at least part of the function related to the function or service from another electronic device (e.g., electronic devices 102 and 104 or a server 106). The other electronic device is capable of executing the requested function or additional functions, and transmitting the result to the electronic device 101. The electronic device 101 processes the received result, or further proceeds with additional processes, to provide the requested function or service. To this end, the electronic device 101 may employ cloud computing, distributed computing, or client-server computing technology.

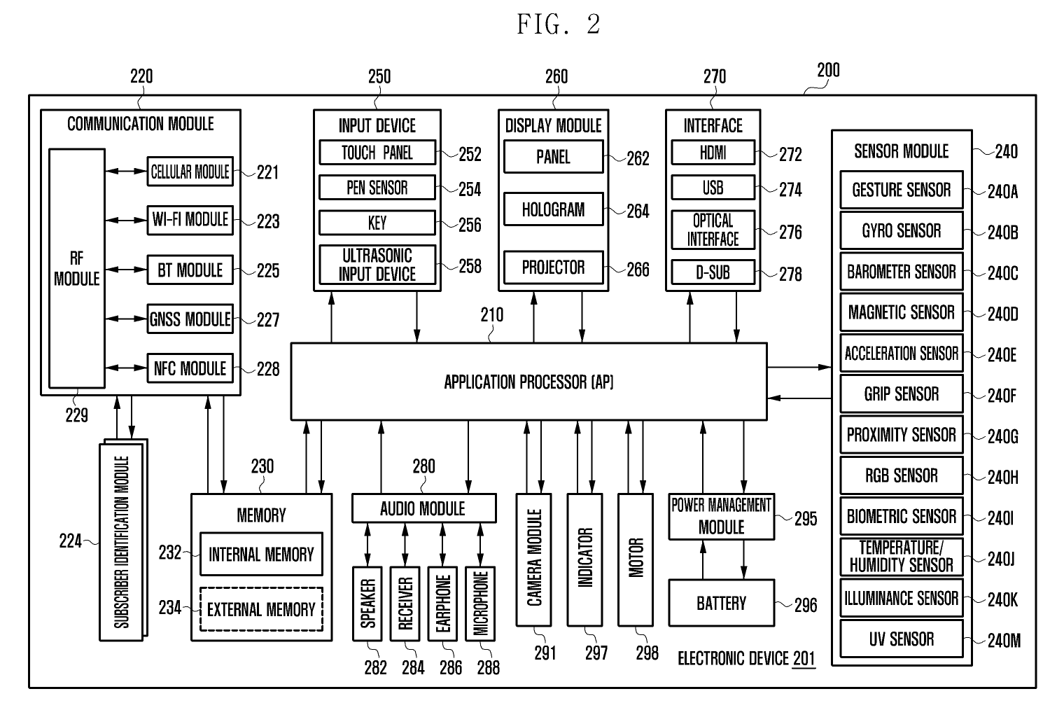

FIG. 2 is a detailed block diagram showing a configuration of an electronic device 201 according to embodiments of the present disclosure. The electronic device 200 of FIG. 2 may include a part or all of the components in the electronic device 101 shown in FIG. 1. The electronic device 201 includes one or more processors 210 (e.g., Application Processors (APs)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 is capable of driving, for example, an operating system or an application program to control a plurality of hardware or software components connected to the processor 210, processing various data, and performing operations. The processor 210 may be implemented as, for example, a system on chip (SoC). According to an embodiment of the present disclosure, the processor 210 may further include a graphic processing unit (GPU) and/or an image signal processor. The processor 210 may also include at least a part of other components shown in FIG. 2, e.g., a cellular module 221. The processor 210 is capable of loading commands or data received from at least one of other components (e.g., a non-volatile memory) on a volatile memory, processing the loaded commands or data. The processor 210 is capable of storing various data in a non-volatile memory.

The communication module 220 may include the same or similar configurations as the communication interface 170 shown in FIG. 1. For example, the communication module 170 may include the cellular module 221, a WiFi module 223, a Bluetooth (BT) module 225, a GNSS module 227 (e.g., a GPS module, Glonass module, Beidou module or Galileo module), an NFC module 228, and a radio frequency (RF) module 229.

The cellular module 221 is capable of providing a voice call, a video call, an SMS service, an Internet service, etc., through a communication network, for example. According to an embodiment of the present disclosure, the cellular module 221 is capable of identifying and authenticating an electronic device 201 in a communication network by using a subscriber identification module (SIM) 224 (e.g., a SIM card). The cellular module 221 is capable of performing at least part of the functions provided by the processor 210. According to an embodiment, the cellular module 221 may also include a communication processor (CP).

Each of the WiFi module 223, the BT module 225, the GNSS module 227, and the NFC module 228 may include a processor for processing data transmitted or received through the corresponding module. According to embodiments of the present disclosure, at least a part of the cellular module 221, WiFi module 223, BT module 225, GNSS module 227, and NFC module 228 (e.g., two or more modules) may be included in one integrated chip (IC) or one IC package.

The RF module 229 is capable of transmission/reception of communication signals, e.g., RF signals. The RF module 229 may include a transceiver, a power amp module (PAM), a frequency filter, a low noise amplifier (LNA), an antenna, etc. According to another embodiment of the present disclosure, at least one of the cellular module 221, the WiFi module 223, the BT module 225, the GNSS module 227, and the NFC module 228 is capable of transmission/reception of RF signals through a separate RF module.

The SIM module 224 may be a SIM card and/or an embedded SIM. The SIM module 224 may contain unique identification information, e.g., an integrated circuit card identifier (ICCID) or subscriber information, e.g., an international mobile subscriber identity (IMSI).

The memory 230 may include a built-in memory 232 or an external memory 234. The built-in memory 232 may include at least one of a volatile memory, e.g., a dynamic RAM (DRAM), a static RAM (SRAM), a synchronous dynamic RAM (SDRAM), etc.; and a non-volatile memory, e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The external memory 234 may include a flash drive, e.g., a compact flash (CF), a secure digital (SD), a micro secure digital (Micro-SD), a mini secure digital (Mini-SD), an extreme digital (xD), a multi-media card (MMC), a memory stick, etc. The external memory 234 is capable of being connected to the electronic device 201, functionally and/or physically, through various interfaces.

The sensor module 240 is capable of measuring/detecting a physical quantity or an operation state of the electronic device 201, and converting the measured or detected information into an electronic signal. The sensor module 240 includes, for example, at least one a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, an illuminance sensor 240K, and a ultraviolet (UV) sensor 240M. Additionally or alternatively, the sensor module 240 may further include an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 may further include a control circuit for controlling one or more sensors included therein. In embodiments, the electronic device 201 is capable of including a processor, configured as part of the processor 210 or a separate component, for controlling the sensor module 240. In this case, while the processor 210 is operating in sleep mode, the processor is capable of controlling the sensor module 240.

The input device 250 may include a touch panel 252, a (digital) pen sensor 254, a key 256, or an ultrasonic input unit 258. The touch panel 252 may be implemented with at least one of a capacitive touch system, a resistive touch system, an infrared touch system, and an ultrasonic touch system. The touch panel 252 may further include a control circuit. The touch panel 252 may also further include a tactile layer to provide a tactile response to the user.

The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, created in an input tool, through a microphone 288, and identifying data corresponding to the detected ultrasonic waves.

The display 260 includes, for example, a panel 262, a hologram unit 264, or a projector 266. The panel 262 may include the same or similar configurations as the display 160 shown in FIG. 1. The panel 262 may be implemented to be flexible, transparent, or wearable. The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. According to an embodiment of the present disclosure, the display 260 may further include a control circuit for controlling the panel 262, the hologram unit 264, or the projector 266.

The interface 270 includes, for example, a high-definition multimedia interface (HDMI) 272, a universal serial bus (USB) 274, an optical interface 276, and a D-subminiature (D-sub) 278. The interface 270 may be included in the communication interface 170 shown in FIG. 1. Additionally or alternatively, the interface 270 may include a mobile high-definition link (MHL) interface, a secure digital (SD) card/multimedia card (MMC) interface, or an infrared data association (IrDA) standard interface.

The audio module 280 is capable of providing bidirectional conversion between a sound and an electronic signal. At least a part of the components in the audio module 280 may be included in the input/output interface 150 shown in FIG. 1. The audio module 280 is capable of processing sound information input or output through a speaker 282, a receiver 284, earphones 286, microphone 288, etc.

The camera module 291 is a device capable of taking both still and moving images. According to an embodiment of the present disclosure, the camera module 291 includes one or more image sensors (e.g., a front image sensor or a rear image sensor), a lens, an image signal processor (ISP), a flash (e.g., an LED or xenon lamp), etc.

The power management module 295 is capable of managing power of the electronic device 201. According to an embodiment of the present disclosure, the power management module 295 is capable of including a power management integrated circuit (PMIC), a charger IC, or a battery gauge. The PMIC may employ wired charging and/or wireless charging methods. Examples of the wireless charging methods include magnetic resonance charging, magnetic induction charging, and electromagnetic charging. To this end, the PMIC may further include an additional circuit for wireless charging, such as a coil loop, a resonance circuit, a rectifier, etc. The battery gauge is capable of measuring the residual capacity, charge in voltage, current, or temperature of the battery 296. The battery 296 takes the form of either a rechargeable battery or a solar battery.

The indicator 297 is capable of displaying a specific status of the electronic device 201 or a part thereof (e.g., the processor 210), e.g., a boot-up status, a message status, a charging status, etc. The motor 298 is capable of converting an electrical signal into mechanical vibrations, such as, a vibration effect, a haptic effect, etc. Although not shown, the electronic device 201 may further include a processing unit (e.g., GPU) for supporting a mobile N. The processing unit for supporting a mobile TV is capable of processing media data pursuant to standards, e.g., digital multimedia broadcasting (DMB), digital video broadcasting (DVB), or mediaFlo™, etc.

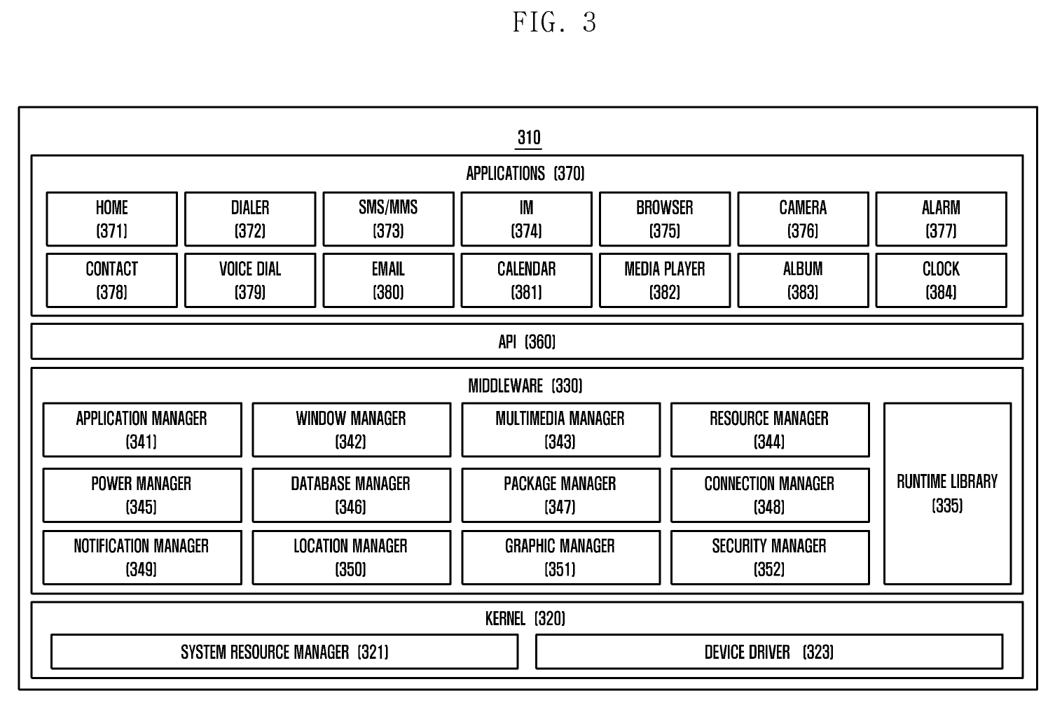

FIG. 3 is a block diagram illustrating a programming module according to an embodiment of the present disclosure.

Referring to FIG. 3, according to an embodiment of the present disclosure, the program module 310 (e.g., program module 140 shown in FIG. 1) ma include an operation system (OS) for controlling resources related to the electronic device (e.g., electronic device 101) and/or various applications (e.g., application programs 147 shown in FIG. 1) running on the OS. The OS may be, for example, Android, iOS, Windows, Symbian, Tizen, Bada, etc.

The program module 310 includes a kernel 320, middleware 330, application programming interface (API) 360 and/or applications 370. At least a part of the program module 310 may be preloaded on the electronic device or downloaded from a server (e.g., an electronic device 102 or 104, server 106, etc.).

The kernel 320 (for example, kernel 141) includes a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth driver, a shared memory driver, a USB driver, a keypad driver, a WiFi driver, and an audio driver. Further, according to an embodiment, the device driver 323 may include an Inter-Process Communication (IPC) driver.

The middleware 330 may provide a function required in common by the applications 370. Further, the middleware 330 may provide a function through the API 360 to allow the applications 370 to efficiently use limited system resources within the electronic device. According to an embodiment of the present disclosure, the middleware 330 (for example, the middleware 143) includes a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352.

The runtime library 335 may include, for example, a library module used by a complier to add a new function through a programming language while the applications 370 are executed. According to an embodiment of the present disclosure, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format required for reproducing various media files and perform an encoding or a decoding of a media file by using a codec suitable for the corresponding format. The resource manager 344 manages resources such as a source code, a memory, or a storage space of at least one of the applications 370.

The power manager 345 may operate together with a basic input/output system (BIOS) to manage a battery or power and provide power information required for the operation. The database manager 346 may manage generation, search, and change of a database to be used by at least one of the applications 370. The package manager 347 may manage an installation or an update of an application distributed in a form of a package file.

The connection manager 348 may manage, for example, a wireless connection such as WiFi or Bluetooth. The notification manager 349 may display or notify a user of an event such as an arrival message, an appointment, a proximity alarm or the like, in a manner that does not disturb the user. The location manager 350 may manage location information of the electronic device. The graphic manager 351 may manage a graphic effect provided to the user or a user interface related to the graphic effect. The security manager 352 provides a general security function required for a system security or a user authentication. According to an embodiment, when the electronic device 101 has a call function, the middleware 330 may further include a telephony manager for managing a voice of the electronic device or a video call function.

The middleware 330 is capable of including modules configuring various combinations of functions of the above described components. The middleware 330 is capable of providing modules specialized according to types of operation systems to provide distinct functions. The middleware 330 may be adaptively configured in such a way as to remove part of the existing components or to include new components.

The API 360 (for example, API 145) may be a set of API programming functions, and may be provided with a different configuration according to an operating system. For example, in Android or iOS, a single API set may be provided for each platform. In Tizen, two or more API sets may be provided.

The applications 370 (e.g., application programs 147) includes one or more applications for performing various functions, e.g., home 371, diary 372, SMS/MMS 373, instant message (IM) 374, browser 375, camera 376, alarm 377, contact 378, voice dial 379, email 380, calendar 381, media player 382, album 383, clock 384, health care (e.g., an application for measuring amount of exercise, blood sugar level, etc.), and environment information (e.g., an application for providing atmospheric pressure, humidity, temperature, etc.).

According to an embodiment of the present disclosure, the applications 370 may include an application for supporting information exchange between the electronic device 101 and one of the external electronic devices 102 and 104, which is hereafter referred to as an ‘information exchange application’). The information exchange application may include a notification relay application for relaying specific information to external devices or a device management application for managing external devices.

For example, the notification relay application may include a function for relaying notification information, created in other applications of the electronic device (e.g., SMS/MMS application, email application, health care application, environment information application, etc.) to the external electronic devices 102 and 104. In addition, the notification relay application capable of receiving notification information from external devices to provide the received information to the user.

The device management application is capable of managing (e.g., installing, removing or updating) at least one function of at least one of the external electronic devices 102 and 104 communicating with the electronic device. Examples of the function include a function of turning-on/off the external device or part of the external device, a function of controlling the brightness (or resolution) of the display, applications running on the external device, services provided by the external device, etc. Examples of the services include a call service, messaging service, etc.

According to an embodiment of the present disclosure, the applications 370 may include an application (e.g., a health care application of a mobile medical device, etc.) specified attributes of at least one of the external electronic devices 102 and 104. The applications 370 are capable of including applications received from the server 106, and electronic devices 102 and 104. The applications 370 may include a preloaded application or third party applications that can be downloaded from a server. Components of the program module 310 may be called different names according to types of operating systems.

According to embodiments of the present disclosure, at least part of the program module 310 may be implemented with software, firmware, hardware, or any combination of two or more of them. At least part of the program module 310 can be implemented (e.g., executed) by the processor 210. At least part of the programing module 310 may include modules, programs, routines, sets of instructions or processes, etc., in order to perform one or more functions.

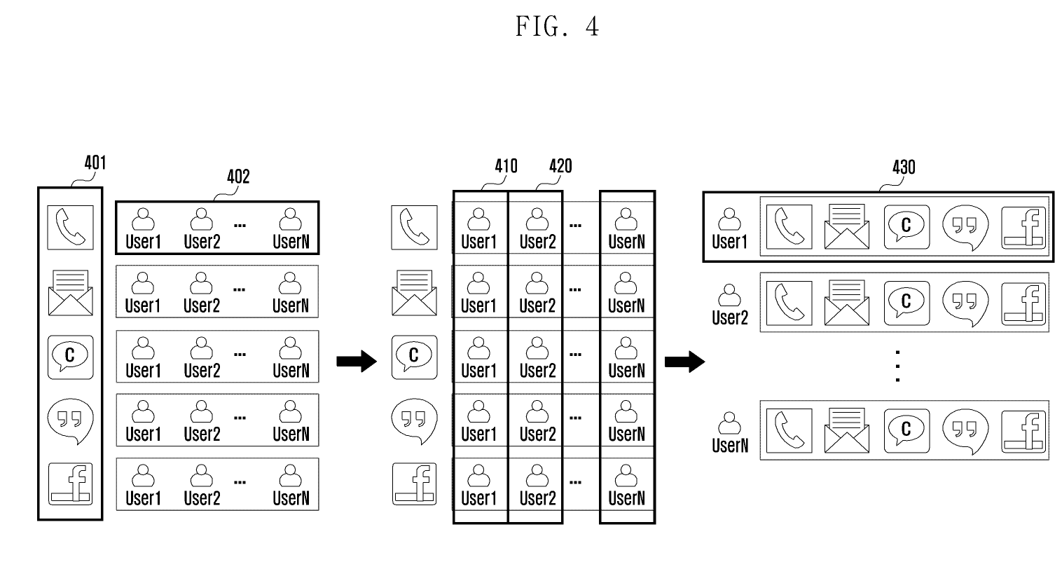

FIG. 4 is a diagram that illustrates a method of switching an application-based notification management mode to a user-based notification management mode according to an embodiment of the present disclosure.

With reference to FIGS. 2 and 4, the electronic device 201 is capable, of installing, to the memory 230, an application 401 (also referred to as a “communication application”) for transmitting/receiving messages or performing a call to/from the other user. The electronic device 201 may include an application for transmitting/receiving a text message or performing a voice call or a video call. For example, the electronic device 201 is capable of performing the transmission/reception of text messages, a voice call or a video call, with the other user, by using contacts and names of the other user stored in the memory 230. The communication application uses a communication application server and is capable of controlling the communication between users based on user information stored in the communication application server. The communication application server receives user information from the electronic device 201 and stores and manages the user information. The communication application server may correspond to one of a number of communication applications. That is, pieces of user information that the communication application servers manage may differ from each other. A communication application is capable of providing its function to a user who has subscribed to the application. Since pieces of subscriber information according to communication applications may differ from each other, pieces of user information that the corresponding communication application servers manage may also differ from each other.

With reference to FIG. 4, communication applications 401 are capable of managing pieces of user information 402 which differ from each other, respectively. Users managed by the communication applications 401 may be the same person. For example, user 1, indicated by reference numeral 410, may be stored, with pieces of information, in the contacts of the electronic device 201 and may also be subscribed, with other pieces of information, to other communication applications. According to the embodiment of FIG. 4, users are stored, with respective corresponding pieces of information, in the contacts of the electronic device 201, and also subscribed, with the same pieces of information, to other communication applications. However, that embodiments of the present disclosure are not limited to the above-described embodiment.

According to embodiments of the present disclosure, the method and the electronic device adapted to the method is capable of integrally managing notifications which are received, based on users, from each communication-related application 401, compared to a general method for an electronic device to manage users based on each communication-related application 401. The electronic device 201 is capable of providing user-based notifications.

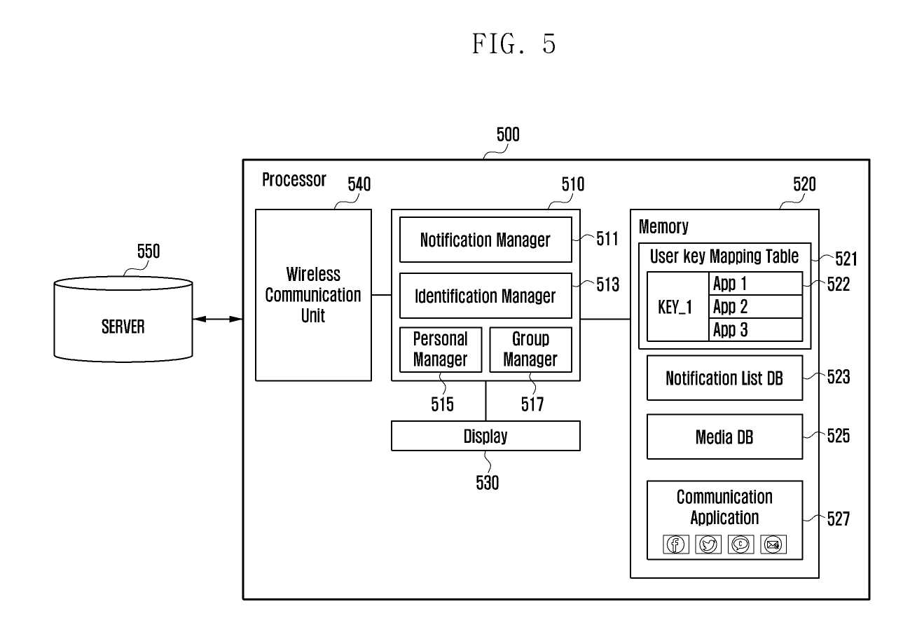

FIG. 5 is a block diagram illustrating a detailed configuration of the electronic device according to an embodiment of the present disclosure.

With reference to FIG. 5, the electronic device 500 (corresponding to the electronic device 101 shown in FIG. 1) includes a processor 510 (corresponding to the processor 120 shown in FIG. 1), a memory 520 (corresponding to the memory 130 shown in FIG. 1), a display 530 (corresponding to the display 160 shown in FIG. 1) and a wireless communication unit 540 (corresponding to the communication interface 170 shown in FIG. 1). Embodiments of the present disclosure are not limited only to the components of the electronic device 500. The electronic device 500 is capable of communicating with an external server 550 (corresponding to the server 106 shown in FIG. 1) via a network (corresponding to the network 162 shown in FIG. 1). The electronic device 500 is capable of communicating with the server 550 based on a communication application 527 installed to the memory 520.

The processor 510 is capable of controlling the memory 520, display 530 and wireless communication unit 540. The processor 510 is connected to the memory 520, display 530, and wireless communication unit 540. The processor 510 may include a circuit for transmitting communications (e.g., control message and data) between the components (e.g., memory 520, display 530, wireless communication unit 540, etc.).

The processor 510 includes a notification manager 511, an identification key manager 513, a personal manager 515, a group manager 517, etc.

When a message related to the communication application 527 arrives from the server 550, the notification manager 511 is capable of notifying the display 530 of the arrival of the message. The notification manager 511 is capable of determining whether it displays a notification of the received message based on communication applications or senders, according to a user's preset view settings. The notification manager 511 is capable of identifying a sender based on an identification key included in the received message, and displaying a notification of an arrival of the received message based on the sender. The notification manager 511 is capable of displaying notifications of the message, according to various view settings. For example, the notification manager 511 is capable of grading the received messages based on senders into levels of public sharing, and displaying the messages according to the graded levels.

The identification key manager 513 is capable of creating and managing an identification key for identifying a message sender. The identification key refers to a unique key for a specified user. The identification key may be created based on a unique key value, such as a phone number, a resident registration number, etc. The identification key may be encrypted for security. The identification key manager 513 is capable of creating an identification key corresponding to a specified user and storing the created identification key in the memory 520. The identification key manager 513 is also capable of identifying a specified user corresponding to the identification key based on identification keys stored in the memory 520.

The personal manager 515 is capable of managing notifications to the user of the electronic device 500 when the user performs inter-personal communication with the other users. The communication application is capable of providing an inter-personal communication service or a group communication service between three or more individuals in a group. The personal manager 515 is capable of managing messages that are transmitted to the user from other users based on an inter-personal communication service.

The group manager 517 is capable of managing notifications to the user of the electronic device 500 when the user performs communication by groups. Unlike the personal manager 515, the group manager 517 is capable of managing messages that are transmitted to the user from groups based on a group communication service. A type of communication service through which the messages are transmitted to the user is identified by the use of a group id stored in the group field from among the information regarding a sender.

The memory 520 may be implemented to include part or all of the memory 230 shown in FIG. 2 or the memory 130 shown in FIG. 1.

The memory 520 is capable of storing a user key mapping table 521, a notification list data base (notification list DB) 523, a media database (media DB) 525, and communication applications. The user key mapping table 521 is created to include a user's identification key, a phone number, a group ID, a user ID for a communication application, etc. For example, the user key mapping table 521 may have a table 522 that includes a user's identification key and IDs for individual communication applications. As described above, although one sender has a number of IDs, the user key mapping table 521 may be a mapping table including an identification key to identify a number of IDs as the same sender.

The notification list DB 523 is formed with received notifications, and adds/deletes notifications thereto/therefrom according to the user's request. The notification list DB 523 changes the stored notifications, in order or location, under the control of the notification manager 511.

The media database 525 is capable of storing media files transmitted from the server 550, such as photos or videos.

The communication application 527 refers to an SNS-related application. For example, the communication application 527 is capable of including applications (e.g., Facebook, KakaoTalk, Skype, etc.) which communicate with other users. That is, the communication application 527 may be an application that provides a service that allows a sender and a receiver to transmit/receive messages to/from each other. The communication application includes communication-based applications installed to the electronic device.

The display 530 (corresponding to the display 160 shown in FIG. 1) may be implemented with a Liquid Crystal Display (LCD). When the LCD is implemented with a touch screen, the display 530 is capable of serving as an input system. The display 530 is capable of displaying, when a notification arrives in the electronic device 500, a user interface showing the notification. For example, the display 530 is capable of displaying a notification on the lock screen or the home screen.

The wireless communication unit 540 (corresponding to the communication interface 170 shown in FIG. 1 or the communication module 220 shown in FIG. 1) is capable of including a cellular module, a WIFI module, a Bluetooth module, a GNSS module, an NFC module and an RF module. The wireless communication unit 540 allows the electronic device 500 to communicate with the server 550.

The server 550 (corresponding to the server 160 shown in FIG. 1) is capable of providing the electronic device 500 with a communication service. The server 550 allows the electronic device 500 to connect to other networks. The server 550 allows the electronic device 500 to share software resources, such as data, programs, etc., and hardware resources, such as a modem, fax, printer, etc.

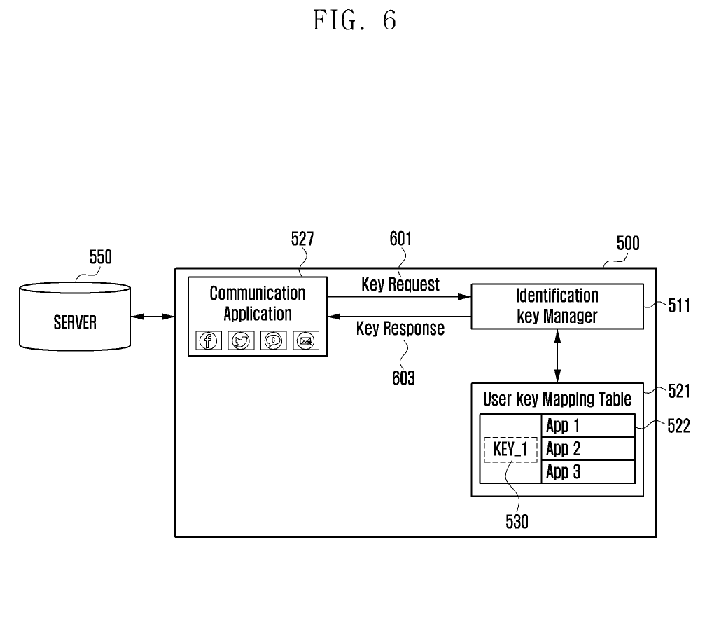

FIG. 6 is a diagram that illustrates a case when the electronic device processes an identification key corresponding to a sender related to a communication event according to an embodiment of the present disclosure.

With reference to FIG. 6, the electronic device 500 is capable of receiving an identification key request 601 from the communication application 527. For example, the electronic device 500 is capable of receiving a notification message based on the communication application 527, from a sender (e.g., an external electronic device user). In this case, the electronic device 500 may also receive the identification key request 601) corresponding to the sender (e.g., an external electronic device) along with the notification message. The identification key request 601 may be a request originating from the communication application 527.

The identification key manager 511 of the electronic device 500 receives the identification key request 601 and searches for an identification key related to the sender (e.g., an external electronic device), stored in the electronic device 500. The identification key manager 511 is capable of identifying information 522 related to the sender, stored in the user key mapping table 521. The identification key manager 511 is capable of identifying an identification key of the sender based on the sender-related information 522. The sender's identification key may be a unique identification value corresponding to the sender, which is previously created in the electronic device 500. The identification key manager 511 is capable of transmitting the identification key response 603 to the communication application 527. The communication application 527 is capable of storing the sender's identification key. When the sender transmits an additional notification message to the electronic device 500, the electronic device 500 ascertains that the received notification message is transmitted from the sender, based on an identification key corresponding to the sender (e.g., an external electronic device).

When the sender's identification key is not stored in the user key mapping table 521, the identification key manager 511 creates the sender's identification key and stores it in the user key mapping table 521. The identification key manager 511 is capable of transmitting the created, sender's identification key to the communication application 527. The communication application 527 is capable of storing the received sender's identification key in connection with the sender. In embodiments of the present disclosure, information related to the sender may be obtained by searching the information stored in the electronic device 500 and also the server 550.

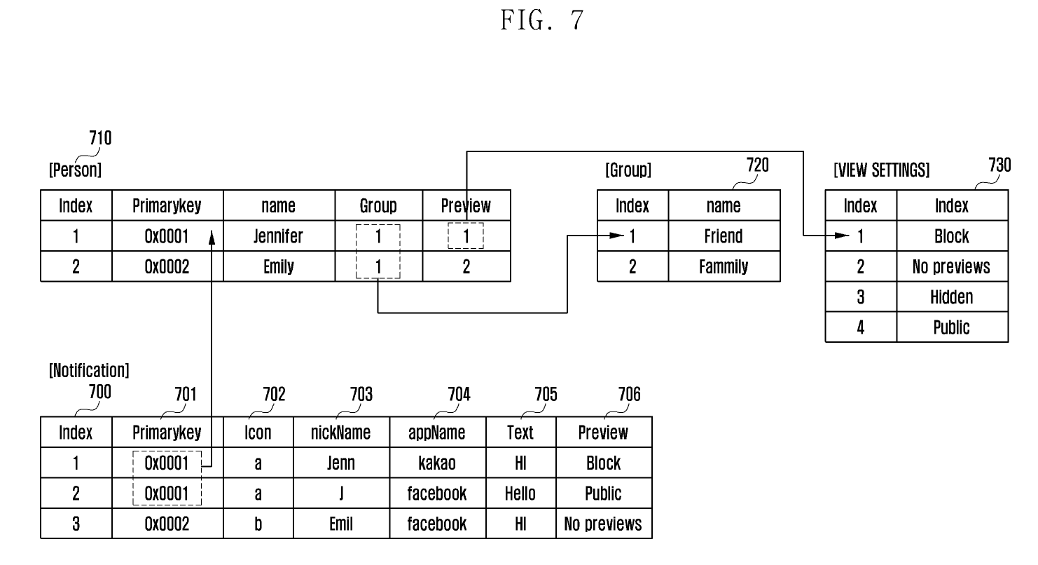

FIG. 7 is a diagram that illustrates the creation of a notification list DB by the electronic device according to an embodiment of the present disclosure.

With reference to FIG. 7, the notification list DB 523 is stored in the memory 520. The identification key manager 513 is capable of creating and managing the user key mapping table 521. For example, the identification key manager 513 is capable of creating a user key mapping table 710 containing information regarding a view settings table 730 and a group table 720. When users are grouped, the group table 720 includes information regarding groups that users belong to. The view settings table 730 includes information modes of displaying notification events, e.g., a mode (e.g., block) where users are blocked so as not to receive their notification messages, a mode (e.g., no previews) where a notification message is received but the notification event is not displayed, a mode (e.g., hidden) where a notification event is only displayed, and a mode (e.g., public) where the content of a notification message is displayed along with the notification event. The identification key manager 513 receives user information from the group table 720 and the view settings table 730, and creates a user key mapping table 710 using the received user information. The user key mapping table 710 is capable of including identification keys, senders' names, senders' group names, and view settings information. The user key mapping table 710 may further include other information related to senders. The notification manager 511 is capable of creating a notification list 700 of notifications transmitted from other users, based on the user key mapping table 710. The notification list 700 is capable of including information regarding the transmission order of notification events, an identification key 701 corresponding to a sender transmitting the notification event, an icon 702 corresponding to a sender, communication application information 704 transmitting a notification event, a sender nickname 703 used in a communication application, a message 705 included in a notification event, view settings 706 corresponding to a sender, etc.

According to embodiments of the present disclosure, the electronic device is capable of identifying a sender based on the notification list 700, and integrally managing notification events transmitted from the sender. Although the electronic device receives a number of notification events via communication applications, the electronic device is capable of identifying senders based on the identification key included in the notification list 700, so that the electronic device provides a notification service that is capable of integrally displaying the notification events according to senders.

According to an embodiment of the present disclosure, an electronic device includes a communication circuit; a display; a processor electrically connected to the communication circuit and the display; and a memory electrically connected to the processor. The processor is capable of receiving at least one communication event or message from at least one external device, via the communication circuit; identifying a user who sent the received, at least one communication event or message, by using identification information which is stored in the memory or is obtained from at least one external device or at least one of the other external devices; creating or extracting notice information, based on at least part of the received, at least one communication event or message; linking the notice information to the identified user; and displaying and overlaying a notice, grouping information regarding the identified user and the notice information, on other objects displayed on the screen of the display. The processor stores instructions to perform the functions described above in the memory.

According to an embodiment of the present disclosure, when identification information is not stored in the memory or cannot be obtained from at least one external device, the electronic device is capable of creating identification information corresponding to the received, at least one communication event or message; and identifying a user who corresponds to the created identification information and sent at least one communication event or message.

According to an embodiment of the present disclosure, the electronic device is capable of transmitting the created identification information to at least one external device.

According to an embodiment of the present disclosure, the electronic device is capable of checking view settings corresponding to the identified user; and displaying and overlaying, based on the checked view settings, the grouped notice on other objects displayed on the screen of the display.

According to an embodiment of the present disclosure, the electronic device performs, based on the view settings, one of blocking the identified user, not displaying the grouped notice, displaying the grouped notice, and displaying content contained in the grouped notice.

According to an embodiment of the present disclosure, the view settings include settings set up according to the identified users and information regarding states of the electronic device user.

According to an embodiment of the present disclosure, the notice includes text or an image corresponding to the identified user. The notice includes at least part of content contained in the received, at least one communication event or message; or the number of received messages and/or communication events.

According to an embodiment of the present disclosure, the identification information includes at least one of an e-mail address, a phone number, a name, and a nickname.

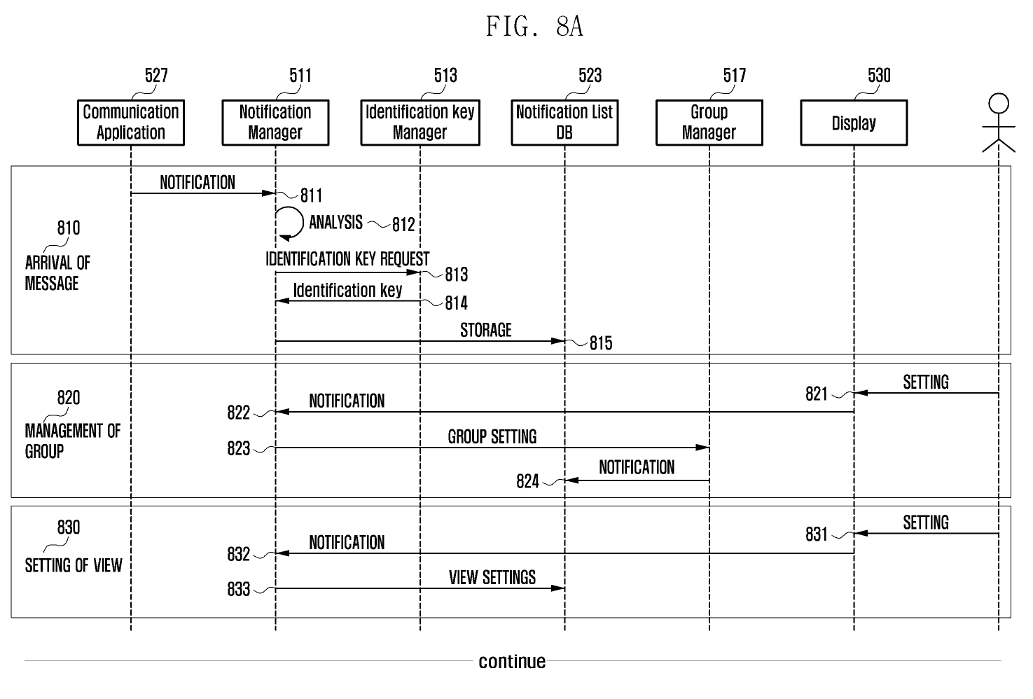

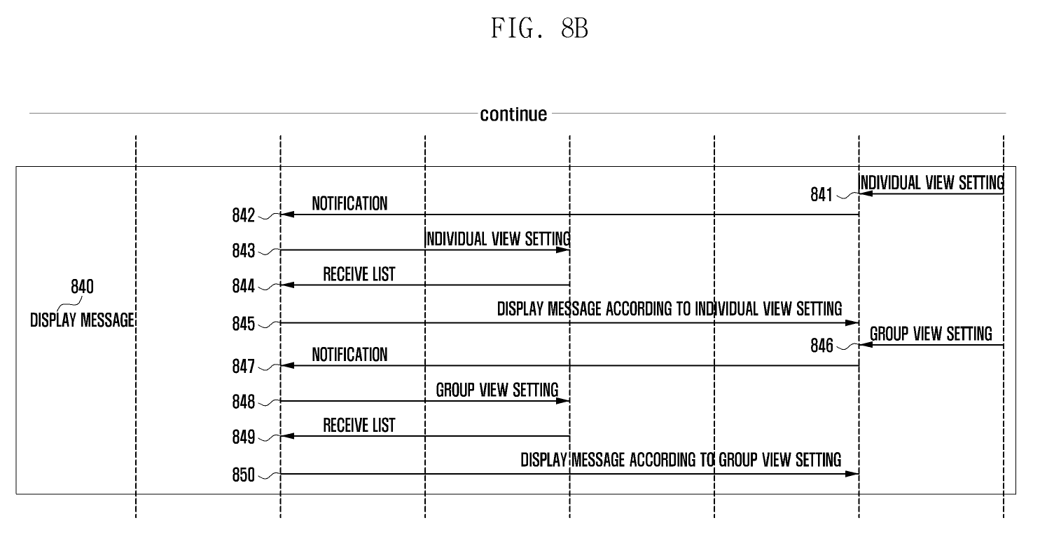

FIGS. 8A and 8B are flow diagrams that illustrate a method of managing senders and displaying notifications according to an embodiment of the present disclosure.

The flow diagrams shown in FIGS. 8A and 8B show processes performed when the electronic device 500 receives communication events and when the user sets up the view settings for users. With reference to operation 810 of FIG. 8A, the communication application 527 transmits notification events to the notification manager 511 of the electronic device 500 in step 811. The notification manager 511 determines whether the notification event is the first notification event transmitted from a sender in step 812. For example, the notification manager 511 is capable of managing a history related to notification events transmitted from a sender, and determining whether the notification event is the first notification event transmitted, for the first time, from sender. When the notification manager 511 ascertains that the notification event is the first notification event transmitted, for the first time, from a sender in step 812, the notification manager 511 requests an identification key corresponding to the sender from the identification key manager 513 in step 813. The identification key manager 513 transmits the identification key corresponding to the sender to the notification manager 511 in step 814. The notification manager 511 stores the notification event in the notification list DB 523 in step 815. That is, the notification events transmitted from the communication application 527 may be stored in the notification list DB 523, as notification events of identification keys corresponding to senders.

Referring to step 820 of FIG. 8A, the electronic device 500 manages groups, under the control of the user. The electronic device 500 detects a user's group setup request via the display 530 in step 821. The electronic device 500 transfers the group setup request to the notification manager 511 in step 822. The notification manager 511 transfers the group setup request to the group manager 517 in step 823. The group manager 517 sets up groups corresponding to the group setup request and stores information regarding the set groups in the notification list DB, in step 824.

Referring to step 830 of FIG. 8A, the electronic device 500 sets the view settings for messages under the control of the user. The electronic device 500 detects a user's view settings request via the display 530 in step 831. The electronic device 500 transfers the view settings request to the notification manager 511 in step 832. The notification manager 511 performs the view settings related to notification events of a specified sender corresponding to the view settings request. The notification manager 511 changes information related to view settings included in the notification list DB 523, and thus changes the view settings in step 833.

Referring to step 840 of FIG. 8B, the electronic device 500 sets view settings according to individuals or groups, under the control of the user, and displays messages based on the view settings. The electronic device 500 detects a user's personal view settings request via the display 530 in step 841. The electronic device 500 transfers the personal view settings request to the notification manager 511 in step 842. The notification manager 511 modifies information related to view settings included in the notification list DB 523, based on the personal view settings request in step 843. Although it is not shown, the personal manager 515 may modify the notification list DB 523 related to the personal view settings. The notification manager 511 receives a notification list from the notification list DB 523 in step 844. The notification manager 511 displays messages according to the personal view settings via the display 530 in step 845.

The electronic device 500 detects a user's group view settings request via the display 530 in step 846. The electronic device 500 transfers the group view settings request to the notification manager 511 in step 847. The notification manager 511 modifies information related to view settings included in the notification list DB 523, based on the group view settings request in step 848. The group manager 517 may modify the notification list DB 523 related to the group view settings. The notification manager 511 receives a notification list from the notification list DB 523 in step 849. The notification manager 511 displays messages according to the group view settings via the display 530 in step 850.

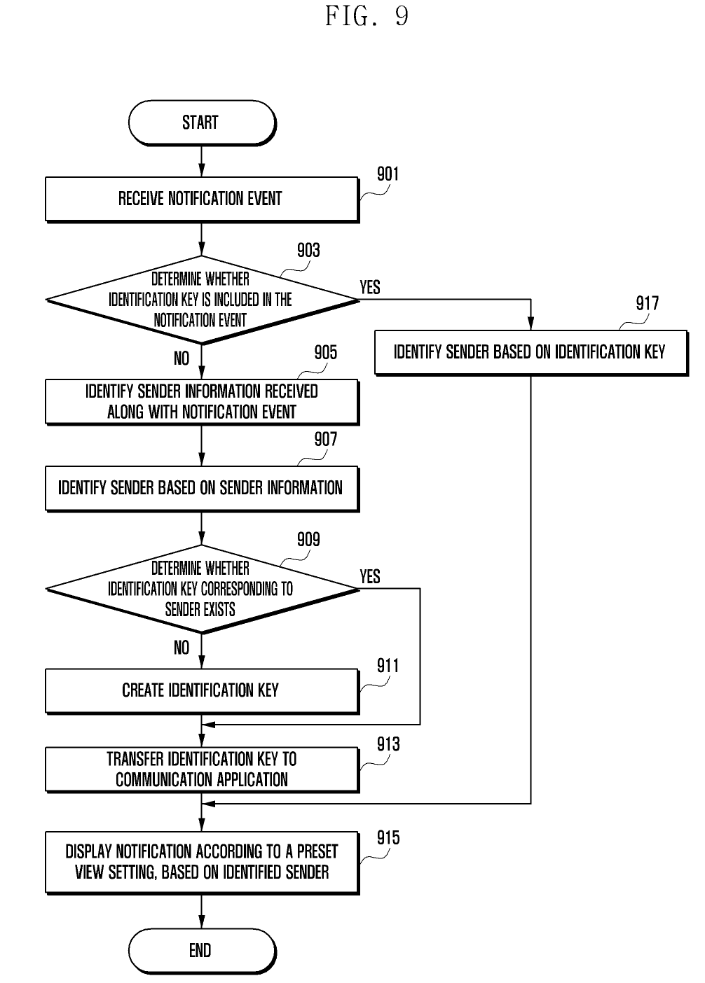

FIG. 9 is a flowchart that illustrates a method for an electronic device to display notifications based on senders related to communication events that occur in the electronic device according to an embodiment of the present disclosure.

With reference to FIGS. 5 and 9, the processor 510 of the electronic device 500 receives notification events via the communication in step 901. The notification events are received via the communication application 527, but are not limited thereto. When a sender is specified to a particular person, the notification events may be transmitted from the specified sender. The processor 510 determines whether an identification key corresponding to the sender is included in the notification event in step 903.

When the processor 510 ascertains that an identification key corresponding to the sender is not included in the notification event in step 903, the processor 510 identifies information regarding the sender (e.g., sender information), received along with the notification event in operation 905. For example, the information regarding the sender, received along with the notification event, may contain the sender's phone number, ID, mail address or e-mail address, etc. The processor 510 identifies a sender based on the sender information in step 907. That is, the processor 510 compares the sender information with information related to senders stored in the memory 520 in order to identify a sender. The processor 510 determines whether an identification key corresponding to the sender exists in step 909. The processor 510 is capable of determining whether an identification key corresponding to the sender exists in the user key mapping table 521 stored in the memory 520.

When the processor 510 ascertains that an identification key corresponding to the sender does not exist in determines 909, the processor 510 is capable of creating an identification key corresponding to the sender in step 911. The processor 510 transfers the identification key to the communication application 527 in step 913. The communication application 527 receives an identification key of a specified sender and stores the identification key along with information regarding the specified sender. When the communication application 527 receives a notification event from the specified sender, the communication application 527 is capable of using the identification key of the specified sender along with the notification event.

However, when the processor 510 ascertains that an identification key corresponding to the sender exists in operation 909, the processor 510 transfers the identification key to the communication application 527 in step 913. Next, as described above, the communication application 527 receives an identification key of a specified sender from the electronic device 500 and stores the identification key along with information regarding the specified sender. When the communication application 527 receives a notification event from the specified sender, the communication application 527 is capable of using the identification key of the specified sender along with the notification event.

The processor 510 displays a notification according to a preset view setting, based on the identified sender in step 915.

However, when the processor 510 ascertains that an identification key corresponding to the sender is included in the notification event in step 903, the processor 510 identifies a sender based on the identification key in step 917. Next, the processor 510 displays a notification according to a preset view setting, based on the identified sender in step 915. As described above, according to embodiments of the present disclosure, when the electronic device receives a notification event, the electronic device identifies a sender based on an identification key included in the notification event and providing a notification service based on the identified sender. When the processor 510 ascertains that an identification key corresponding to the sender does not exist in step 913, the processor 510 creates an identification key and providing the created identification key to the communication application 527.

According to an embodiment of the present disclosure, the process of providing an identification key to the communication application 527 includes creating an identification key corresponding to the sender when the first notification event is received from the communication application 527; and providing the created identification key to the communication application 527. Alternatively, when a communication application 527 is, initially, for the first time, installed to the electronic device 500, the electronic device 500 is capable of providing the communication application 527 with an identification key corresponding to the sender, based on the contacts stored in the memory 520.

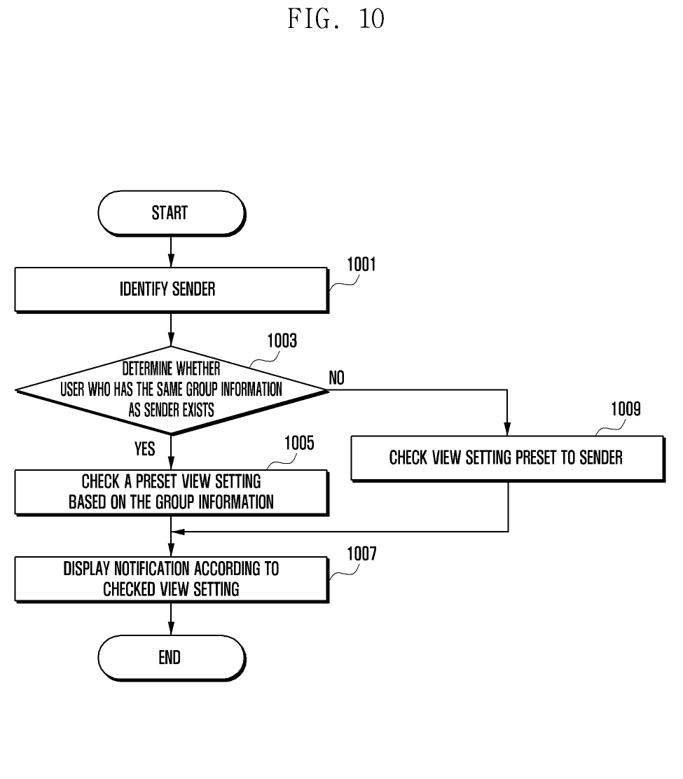

FIG. 10 is a flowchart that illustrates a method for an electronic device to display notifications, based on individuals or groups, according to an embodiment of the present disclosure. That is, FIG. 10 is a detailed flowchart of operation 915 shown in FIG. 9.

With reference to FIG. 10, the processor 510 identifies a sender who sent a notification event in step 1001. That is, the processor 510 identifies information corresponding to the sender from the user key mapping table 521. The processor 510 determines whether a user, who has the same group information as the sender does, exists in step 1003.

When the processor 510 ascertains that a user, who has the same group information as the sender does, exists in operation 1003, the processor identifies the preset view settings, based on the group information, in step 1005. The processor 510 displays a notification (i.e., a message) according to the checked view settings in step 1007.

However, when the processor 510 ascertains that a user, who has the same group information as the sender does, does not exist, in step 1003, the processor 510 checks the preset view settings, based on the sender in step 1009. That is, the processor 510 ascertains that there is no group formed with the sender, and checks the view settings based on the sender. The processor 510 displays a notification (message) according to the checked view settings in step 1007.

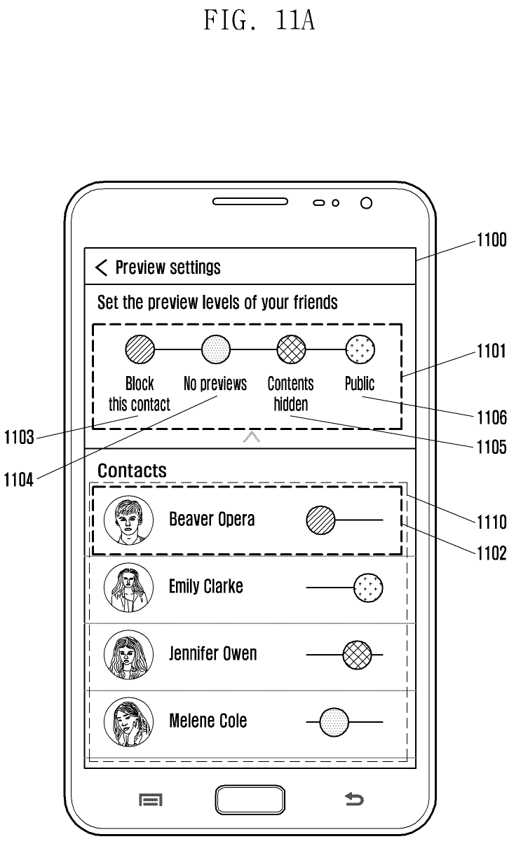

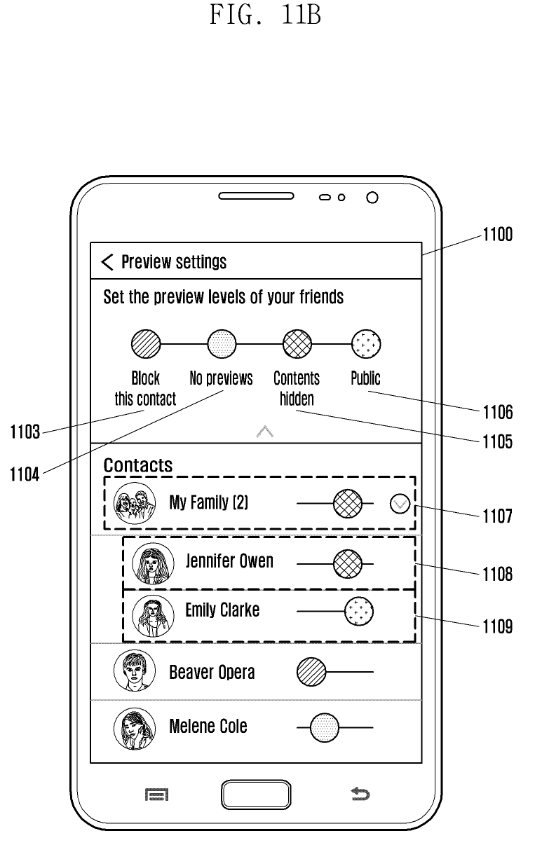

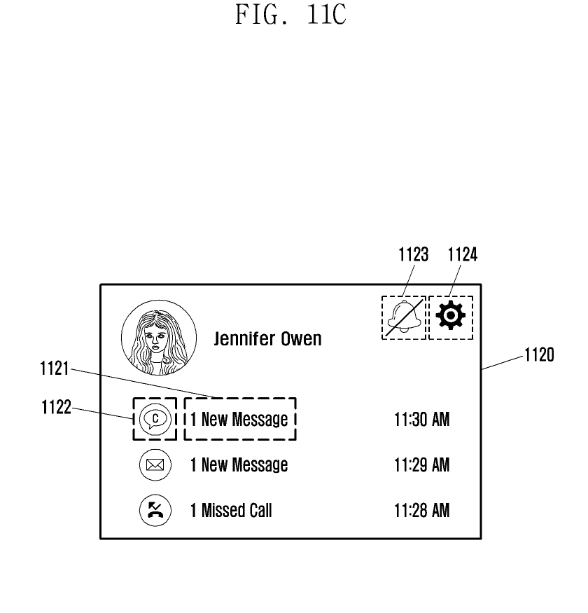

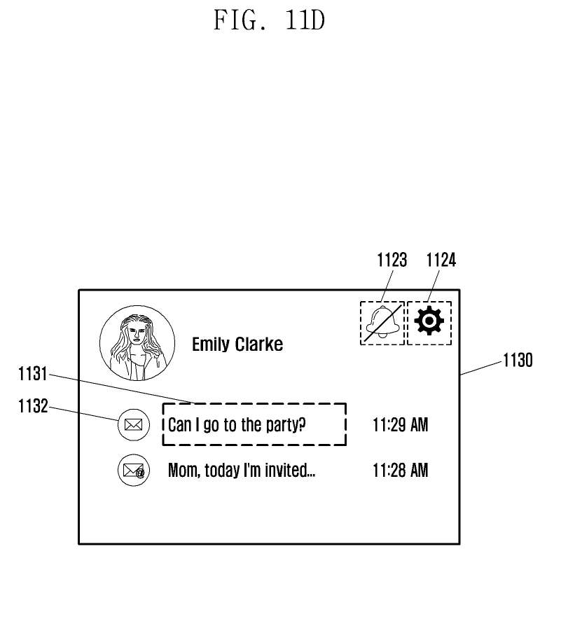

FIGS. 11A and 11B are diagrams illustrating a method of setting view settings for notifications based on individuals or groups according to an embodiment of the present disclosure.

FIG. 11A is a diagram showing a screen where view settings according to individuals, related to notification events, are set in the electronic device 500. With reference to FIG. 11A, the display 530 of the electronic device 500 displays a notification view settings screen 1100. The notification view settings screen 1100 may be configured to include an area 1101 describing the levels of view settings and an area 1110 for setting view settings according to senders (users) stored in the contacts.

With reference to the area 1101, which depicts the levels of view settings, the processor 510 of the electronic device 500 is capable of defining the view settings to be set in four levels (e.g., block this contact 1103, no previews 1104, content hidden 1105, and public 1106). Although there are four levels in the view settings of the present example, embodiments of the disclosure are not limited a particular number of levels. In the present example according to an embodiment of the present disclosure, the processor 510 is capable of setting the view settings in four levels as follows. First, ‘block this contact’ may be defined as a setting to block a sender or a setting that receives a notification event from the blocked sender but does not display the notification event. Examples of the notification event are an incoming call, an incoming message, etc. Second, ‘no preview’ may be defined as a setting that receives notification events but does not display the notification events separately. Third, ‘content hidden’ may be defined as a setting that displays a notification event but does not display a message transmitted along with the notification event. For example, ‘content hidden’ may be a setting that displays a notification icon on the screen but does not display the message. Fourth, ‘public’ may be a setting that display all received notification events and messages transmitted along with the notification events on the screen. The levels of view settings may be distinguished from each other, by varying color, brightness, shade, size of icon, etc.

With reference to the area 1110 for setting view settings according to senders (users) stored in the contacts, the processor 510 is capable of individually displaying users stored in the contacts. The processor 510 is capable of setting view settings corresponding to individual users. For example, a user 1102, Beaver Opera, is stored in the contacts, and the view settings for Beaver Opera 1102 is set as ‘block this contact.’ In this case, the ‘block this contact’ view settings enable the processor 510 to block all contacts (e.g., notification events, calls, messages, etc.) sent from Beaver Opera 1102. The processor 510 may set the view settings for Emily Clarke as ‘public.’ That is, the ‘public’ view settings enable the processor 510 to display notifications of all events from Emily Clarke and the content of the notifications.

According to embodiments of the present disclosure, the view settings according to individuals stored in the contacts may be set respectively.

FIG. 11B is a diagram illustrating a screen where view settings according to groups, related to notification events, are set in an electronic device according to an embodiment of the present disclosure.

With reference to FIG. 11B, the electronic device 500 is capable of managing contacts based on grouping. The electronic device 500 is capable of setting view settings according to groups. For example, the processor 510 is capable of creating a group named a group name ‘my family 1107,’ where Jennifer Owen 1108 and Emily Clarke 1109 may be included. The processor 510 is capable of setting the view settings for the ‘my family 1107’ group as ‘content hidden.’ In the embodiment of FIG. 11B, the settings according to groups may be the general view settings for all groups. The processor 510 may set view settings according to individuals in the group, separately, according to a user's settings. For example, the processor 510 may set Jennifer Owen 1108 to a view setting ‘content hidden’ and Emily Clarke 1109 to ‘public.’ The processor 510 is capable of initially displaying notifications based on the view settings according to groups. When users in a group have been set to different view settings that differ from each other, the processor 510 may display notifications based on individual settings.

FIGS. 11C and 11D are diagrams that illustrate a method of displaying notifications according to an embodiment of the present disclosure.

FIG. 11C illustrates a notification window 1120 showing a communication application icon 1122 corresponding to a received notification event, and the number of received notification events 1121. With reference to FIG. 11C, when notification events arrive from a specified sender, the processor 510 is capable of displaying information regarding the received notification events. For example, the processor 510 is capable of receiving communication application-based messages from a sender, Jennifer Owen. With reference to the notification window 1120, the processor 510 displays a profile image of the sender, Jennifer Owen, and a sender name (e.g., a name stored in the contacts). The processor 510 may also display a communication application icon 1122 and the number of messages 1121 received via the communication application on the notification window 1120. The processor 510 is capable of displaying a sound settings icon 1123 and a view settings icon 1124, related to notification. That is, the processor 510 is capable of setting view for senders on the notification window 1120. The notification window 1120 as shown in FIG. 11C may be an example showing one of the four levels of view settings, ‘content hidden,’ as described above referring to FIG. 11A. The processor 510 has set the view settings for a sender, Jennifer Owen, to ‘content hidden’, and shows one missed call, 11:28 A.M. from the sender, Jennifer Owen, one unread new message 11:29 A.M., and one communication application message, 11:30 A.M. on the notification window 1120. According to an embodiment of the present disclosure, the electronic device is capable of integrally displaying notification events which are received based on senders. The electronic device is capable of integrally displaying various types of notification events received from one sender or individual senders, based on senders.

FIG. 11D illustrates a notification window 1130 showing a communication application icon 1132 corresponding to a received notification event, and the message content 1131 included in the received notification event. The notification window 1130 shows a sender's profile image and a sender name. The notification window 1130 also shows a sound settings icon 1123 and a view settings icon 1124, related to the notification event. The processor 510 of the electronic device 500 is capable of displaying a communication application icon 1132 corresponding to a notification event, along with the message content included in the notification event. The processor 510 is capable of integrally displaying various types of notification events received from one sender or individual senders, based on senders.

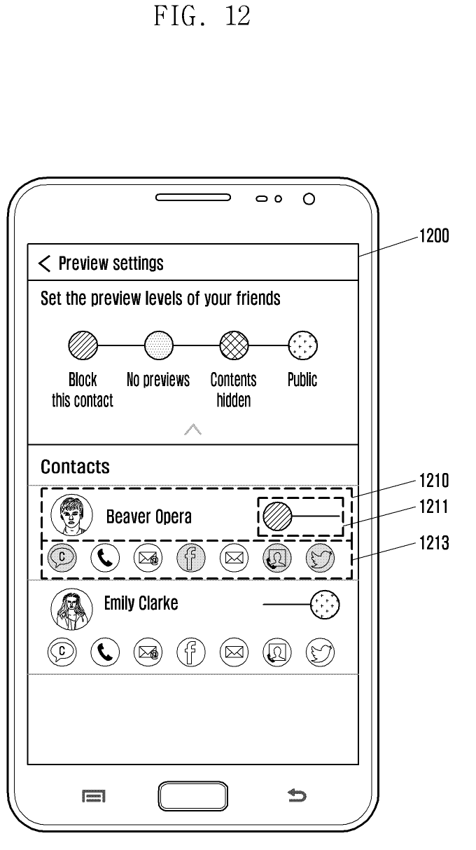

FIG. 12 is a diagram that illustrates a method of setting view settings for notifications according to sender-based applications, according to an embodiment of the present disclosure.

With reference to FIG. 12, the electronic device 500 is capable of displaying a notification view settings screen 1200 based on senders on the display 530. Like the notification view settings screen shown in FIG. 11A, the notification view settings screen 1200 shown in FIG. 12 may be configured to include an area describing the levels of view settings and an area for setting view settings according to senders (users) stored in the contacts. The notification view settings screen 1200 may include communication application icons that are related to senders, respectively. The notification view settings screen 1200 may display only notifications corresponding to communication applications selected by a user. For example, the processor 510 is capable of displaying a sender's profile image and name stored in the contacts 1210. The processor 510 is capable of displaying communication application icons related to the sender 1213. The processor 510 is capable of displaying a user's selected communication application icons from among the displayed communication application icons 1213, in a visually distinctive manner. The processor 510 is capable of setting view settings related to a communication application corresponding to a selected communication application icon 1211. According to an embodiment of the present disclosure, the electronic device is capable of settings sender-based notification view settings, i.e., the view settings according to communication applications.

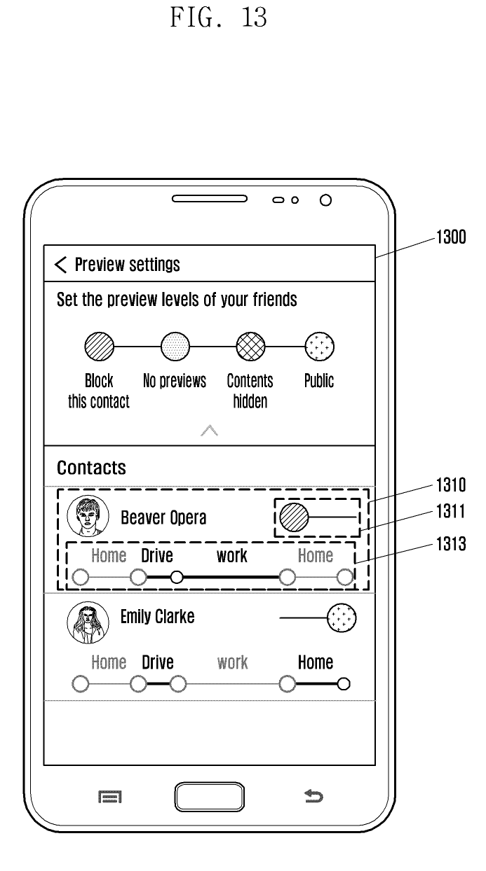

FIG. 13 is a diagram that illustrates a method of setting view settings for notifications of senders, considering a context of the receiver, according to an embodiment of the present disclosure.

With reference to FIG. 13, the electronic device 500 is capable of displaying sender-based notification view settings screen 1300 on the display 530. Like the notification view settings screen shown in FIG. 11A, the notification view settings screen 1300 shown in FIG. 13 may be configured to include an area describing the levels of view settings and an area for setting view settings according to senders (users) stored in the contacts. The notification view settings screen 1300 is capable of setting the notification view settings considering a receiver's context. For example, the processor 510 is capable of displaying a sender's profile image and name stored in the contacts 1310. The processor 510 is capable of setting the view settings according to a receiver's contexts (i.e., circumstances) 1313. The “receiver” may refer to a user receiving notification events, i.e., a user of the electronic device 500. The expression “receiver's context” may refer to a receiver's current state. For example, a receiver's a current state may be a context where a receiver is home, a context where a user is driving, a context where a user is at a work site, etc. A user's current state may be altered according to the settings. For example, when a receiver is in a context in which the receiver leaves the office and is home, the receiver may set the notification view settings to restrict the notifications sent from the office workers. The processor 510 is capable of setting the view settings for notifications based on a user's context 1311.

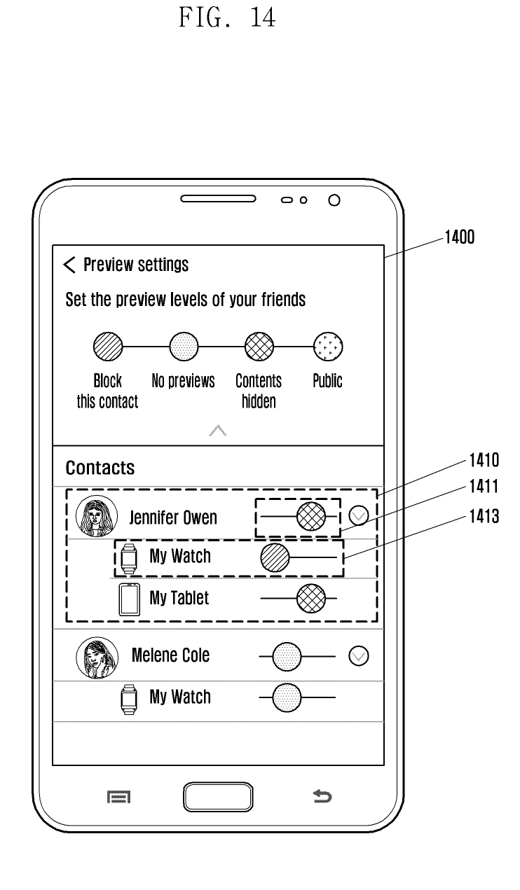

FIG. 14 is a diagram that illustrates a method of setting view settings for notifications of senders, according to the user's owned electronic devices, according to an embodiment of the present disclosure.

With reference to FIG. 14, the electronic device 500 is capable of displaying a notification view settings screen 1400 based on senders on the display 530. The processor 510 is capable of setting the notification view settings according to senders (e.g., sender ‘Jennifer Owen’ 1410) on the notification view settings screen 1400. The processor 510 is capable of setting the view settings that differ from each other, according to a receiver's owned electronic devices (e.g., a watch, a wearable device, a tablet, etc.), in order to display a sender's notifications 1413. For example, while the view settings for all notifications from sender Jennifer Owen 1410 are set to ‘content hidden’ 1411, the notification view settings for the receiver's watch may be set to ‘block this contact’ 1413. According to an embodiment of the present disclosure, the notification view settings may be set to differ from each other, according to a receiver's electronic devices, in displaying user-based notifications.

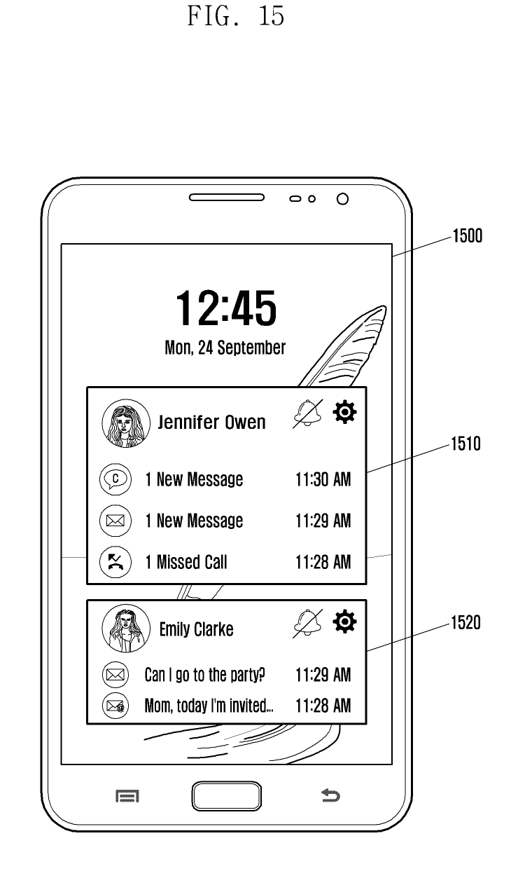

FIG. 15 is a diagram that illustrates a method of displaying notifications in a lock screen state, based on senders, according to an embodiment of the present disclosure.

With reference to FIG. 15, the electronic device 500 is capable of displaying sender-based notification windows 1510 and 1520 on a lock screen 1500 on the display 530. Notification windows based on notification events may be displayed in integration with sender-based notification events.

For example, when the electronic device receives one missed call, one text message, and one application message from a same sender, Jennifer Owen, the processor 510 is capable of displaying the three notification events on the sender-based notification window 1510. The processor 510 may have set the view settings for Jennifer Owen to ‘content hidden’ (such as in the content hidden setting 1105, shown in FIG. 11A), and may display only the number of notification events.

When the electronic device 500 receives one text message and one e-mail from another sender, Emily Clarke, the processor 510 is capable of displaying the two notification events on the sender-based notification window 1520. The processor 510 may have set the view settings for Emily Clarke to ‘public’ (such as in the public setting 1106 shown in FIG. 11A), and may display the message content included in the notification events.

In embodiments of the present disclosure, received notification events may be integrally displayed based on senders. That is, the electronic device is capable of receiving notification events from senders and integrally displaying the notification events based on the senders so that the user can intuitively identify the senders who sent the notification events.

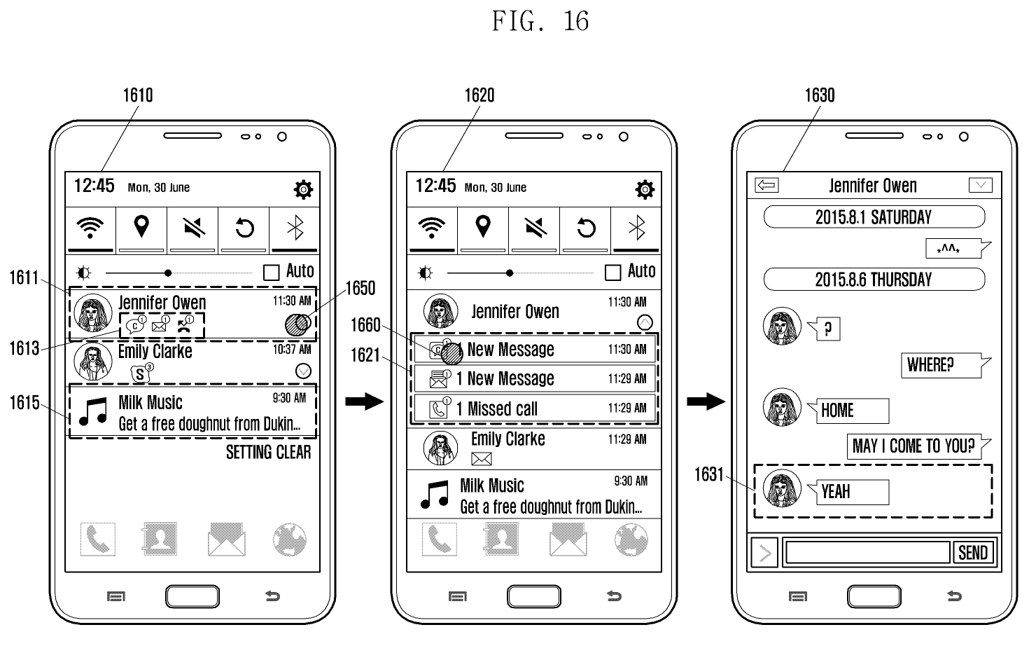

FIG. 16 includes diagrams that illustrate a method of displaying notifications on a QuickPanel, based on senders, according to an embodiment of the present disclosure.

With reference to FIG. 16, the electronic device 500 is capable of displaying sender-based notification events on a QuickPanel screen. The QuickPanel screen refers to a screen that is provided by the electronic device 500 and displays notifications and types of settings related to the electronic device 500. For example, the QuickPanel screen may be the highest layer of a screen created when a swipe gesture is made from the edge to the center of the display 530 of the electronic device 500.

The screen 1610 may be the QuickPanel screen shown when a notification event is received. The screen 1610 shows icons for setting default functions such as a Wi-Fi setting, a GPS setting, a volume, etc., and also a notification event 1613 received from a sender, Jennifer Owen, 1611. When a user input 1650 is applied to the notification of the sender, Jennifer Owen 1611, on screen 1610, the processor 510 is capable of displaying detailed notification events 1621 received from the sender, Jennifer Owen 1611, according to applications. For example, the processor 510 is capable of displaying one messenger application-based message, one text message, and one missed call 1621 on the screen 1620. When a user input 1660 is applied to one of the notification events 1621 displayed according to applications on the screen 1620, the processor 510 is capable of displaying an application screen corresponding to the user input 1660 on the screen 1630. For example, when a user input is applied to a specified communication application-based message, the processor 510 is capable of displaying the specified communication application screen and the message based on the communication application.

With reference to the screen 1610, the processor 510 is capable of displaying both the sender-based notification event 1611 and the specified application-based notification event 1615. For example, received application-based notification events may also include notification events transmitted from senders who are not important to the user (e.g., senders who send spam, advertisements, announcements, etc.). In this case, the processor 510 is capable of displaying notification events transmitted from senders who are not important to the user, so as to be distinguished from an application-based notification event 1615. That is, the user may set senders, distinguishing senders who are important to the user from senders who are not important to the user. Alternatively, the processor 510 may display notification events received from senders who are not important to the user, as application-based notification events; and display notification events received from senders who important to the user, as sender-based notification events.

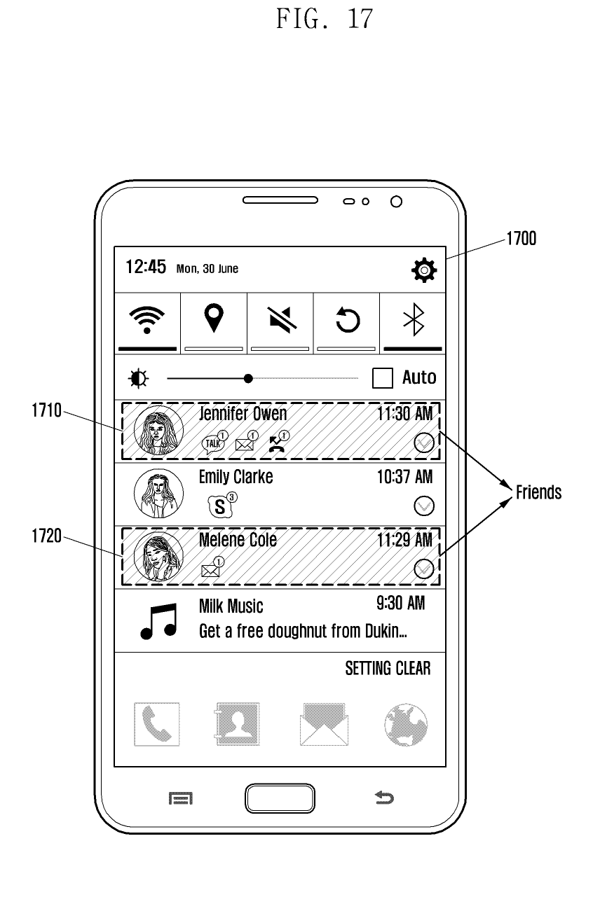

FIG. 17 is a diagram that illustrates a method of displaying senders that belong to the same group, in same color, on the QuickPanel, according to an embodiment of the present disclosure.

With reference to FIG. 17, the screen 1700 may be the same QuickPanel screen as shown in FIG. 16. The screen 1700 is capable of integrally displaying notification events received from senders. For example, the screen 1700 is capable of integrally displaying notification events from Jennifer Owen 1710, and also notification events from Emily Clarke and Melene Cole 1720. Jennifer Owen 1710 and Melene Cole 1720 are friends and are set to have a friend status in the contacts of the electronic device 500. The processor 510 is capable of displaying notification events received from Jennifer Owen 1710 and Melene Cole 1720, in the same color, on the screen 1700. According to an embodiment of the present disclosure, when the electronic device receives notification events from senders who are friends of the user, the electronic device is capable of displaying the notification events in same color so that the user can intuitively recognize the senders.

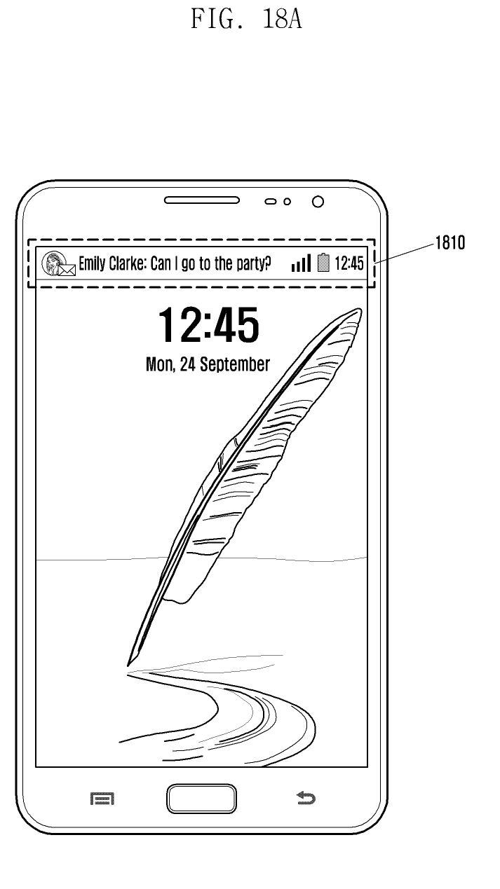

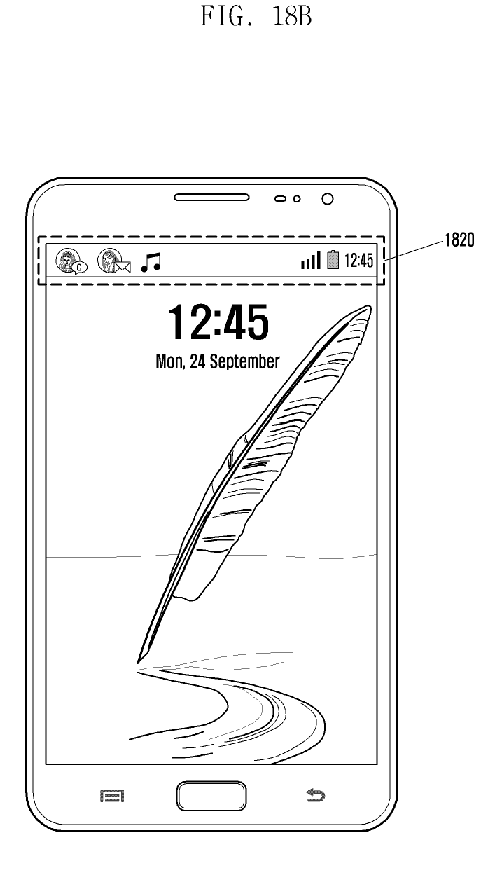

FIGS. 18A and 18B are diagrams illustrating a notification displayed via the indicator according to an embodiment of the present disclosure.

With reference to FIG. 18A, the electronic device 500 is capable of displaying a sender's profile image, a communication application, a sender's name, and message content included in a notification event, via the indicator on the display 530. The processor 510 of the electronic device 500 may set the view settings of a sender Emily Clarke to ‘public’ (refer to ‘public 1106’ shown in FIG. 11A).

With reference to FIG. 18B, the electronic device 500 is capable of displaying a sender's profile image and a communication application, via the indicator on the display 530. The processor 510 may set the view settings of a sender Emily Clarke to ‘content hidden’ (such as in the content hidden setting 1105 shown in FIG. 11A).

According to an embodiment of the present disclosure, sender-based notification events may be displayed via the indicator.

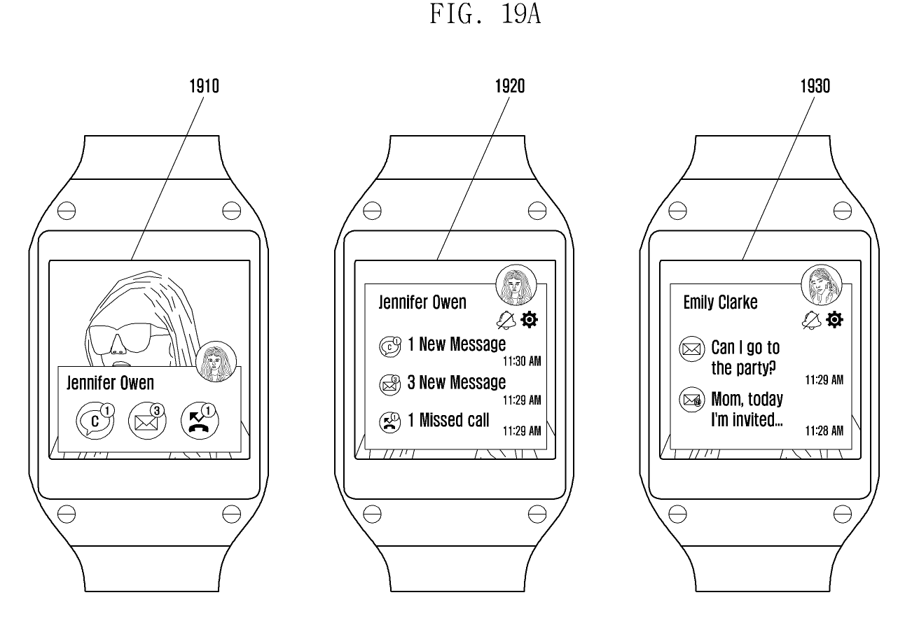

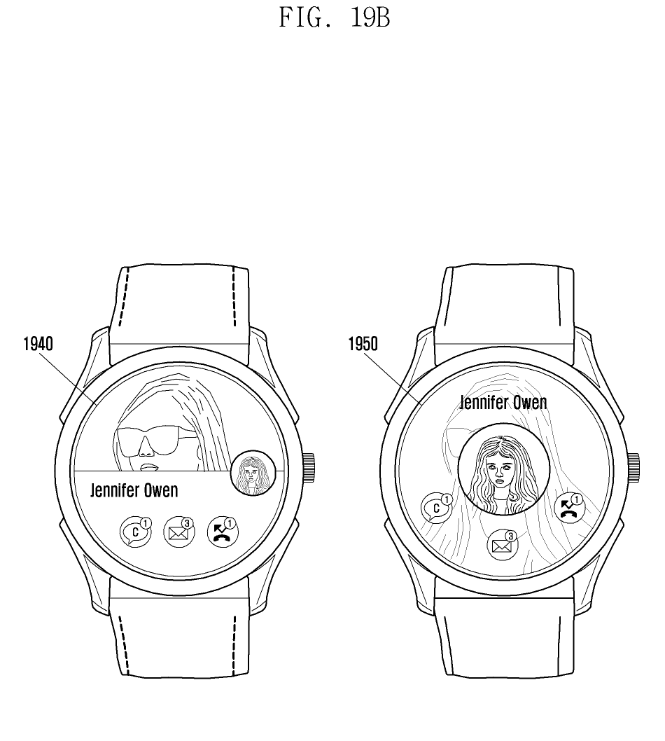

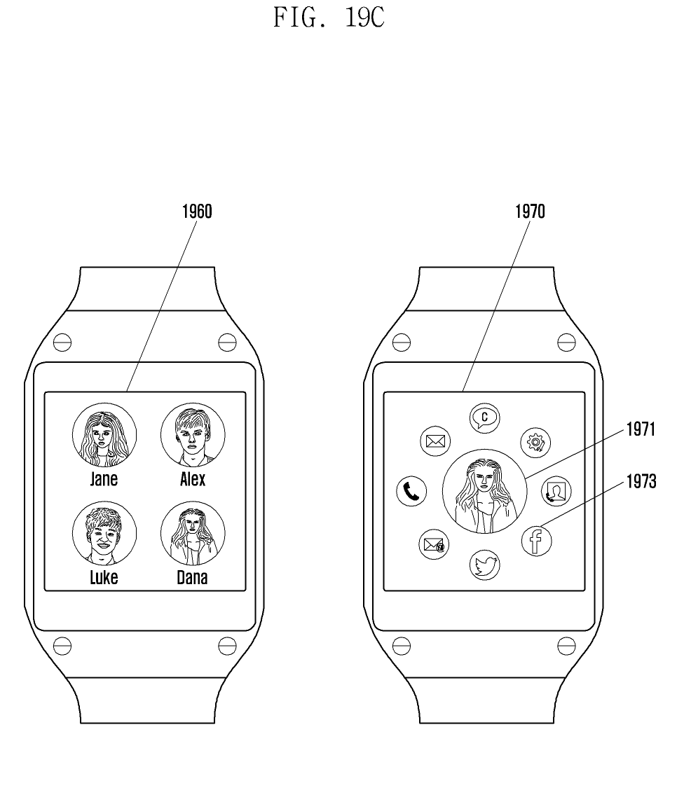

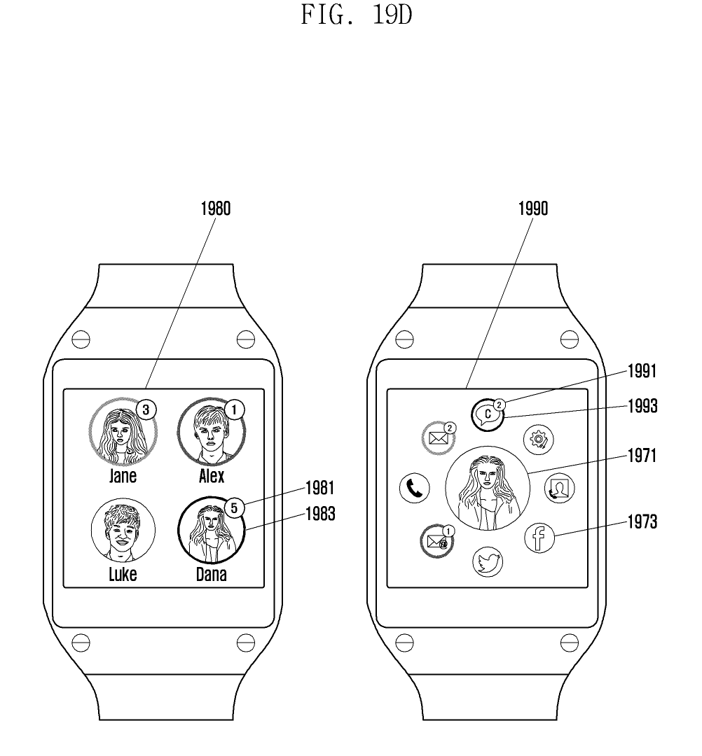

FIGS. 19A to 19D are diagrams illustrating wearable electronic devices displaying notifications according to an embodiment of the present disclosure.

FIG. 19A shows diagrams of a watch, as an example of a wearable electronic device that displays notification events. The watch displays a sender-based notification window, as shown in diagrams 1910, 1920, and 1930. For example, as shown in diagram 1910, when the watch receives a notification event from a sender Jennifer Owen, the processor of the watch is capable of displaying both an application icon and a number of notification events. As shown in diagram 1920, when the watch receives a notification event from a sender Jennifer Owen, the watch processor is capable of displaying the application icon, the number of notification events, reception times of notification events, etc. The watch processor is capable of displaying a sound setting icon and a notification view settings icon on the screen shown in diagram 1920. The watch processor may set the view settings of a sender Jennifer Owen to ‘content hidden’ (such as in the content hidden setting 1105 shown in FIG. 11A) as shown in diagram 1920. When the watch receives notification events from another sender Emily Clarke, the watch processor is capable of displaying the application icon and the message content included in the notification events as shown in diagram 1930. The watch processor may set the view settings of sender Emily Clarke to ‘public’ (such as in the public setting 1106 shown in FIG. 11A) as shown in diagram 1930.

Embodiments of the present disclosure may also be applied to other types of wearable electronic devices and display user interfaces in various styles according to notification view settings.

FIG. 19B includes diagrams illustrating a watch with a circular screen as an example of a wearable electronic device displaying notification events according to an embodiment of the present disclosure. For example, when the watch receives notification events from a sender Jennifer Owen, the watch processor is capable of displaying the application icon and the number of notification events as shown in diagram 1940. As shown in diagram 1950, the watch processor may display the received notification events on the screen of the watch, configured in such a way that the sender's profile image is located in the center of the screen and the application icons are around the sender's profile image.

FIG. 19C includes diagrams illustrating a watch with a rectangular screen as an example of a wearable electronic device that displays notification events according to an embodiment of the present disclosure. For example, when the watch receives notification events, the watch processor is capable of displaying the sender's profile image of the received notification events as shown in diagram 1960. The watch processor is capable of detecting a user input applied to the sender's profile image. For example, when the watch processor detects a user input applied to Dana, the watch processor configures the screen in such a way that Dana's profile image 1971 is located at the center of the screen and the application icons 1973 are around Dana's profile image 1971 as shown in diagram 1970. The application icons are icons of applications that are capable of communicating with Dana or correspond to the notification events.

FIG. 19D includes diagrams illustrating a watch displaying notification events according to an embodiment of the present disclosure. For example, as shown in diagram 1980, the watch processor is capable of displaying senders' profile images of received notification events and the number of unread notification events 1981, respectively. The watch processor is capable of displaying a profile image of a sender corresponding to the latest received notification event, the edge 1983 of which is distinguished from the other profile images. For example, when the latest received notification event is a missed call, the watch processor may display the edge 1983 of the sender's profile image in green. When the latest received notification event is a text message, the watch processor may display the edge 1983 of the sender's profile image in white. Although, according to the embodiment of FIG. 19D, the latest received notification event is distinguished from the other events by varying the color of the profile image edge 1983 as shown in diagram 1980, embodiments the present disclosure are not limited in this manner. As shown in diagram 1980, the watch processor displays five notification events from a sender, Dana, and also the type of the latest received notification event from Dana in the same color as the profile image edge 1983.

The watch processor is capable of detecting a user input applied to a sender's profile image on the screen as shown in diagram screen 1980. For example, when the watch processor detects a user input applied to Dana, the watch processor configures the screen in such a way that Dana's profile image 1971 is located at the center of the screen and the application icons 1973 are around Dana's profile image 1971 as shown in diagram 1990. The watch processor is capable of displaying five notification events transmitted from Dana on the screen as shown in diagram 1980, and types of communication applications that correspond to the five notification events respectively on the screen as shown in diagram 1990. For example, the watch processor is capable of displaying notifications of two text messages, two messages based on a messenger application, and one e-mail, from Dana, on the screen as shown in diagram 1990. The watch processor is capable of displaying edges 1993 of communication applications in color colors. In this case, the user can recognize that the latest received notification is a messenger application-based message notification, based on the color of edge 1993. The color of the profile image edge 1983 displayed on the screen shown in diagram 1980 may be identical to the color of the edge 1993 of the messenger application icon. Various embodiments of the present disclosure are capable of displaying, based on senders, the number of received notification events, respectively, and communication applications corresponding to notification events in such a way that one communication application corresponding to the latest received notification event displays the edge in a color that differs from those of the edges of the other communication applications.

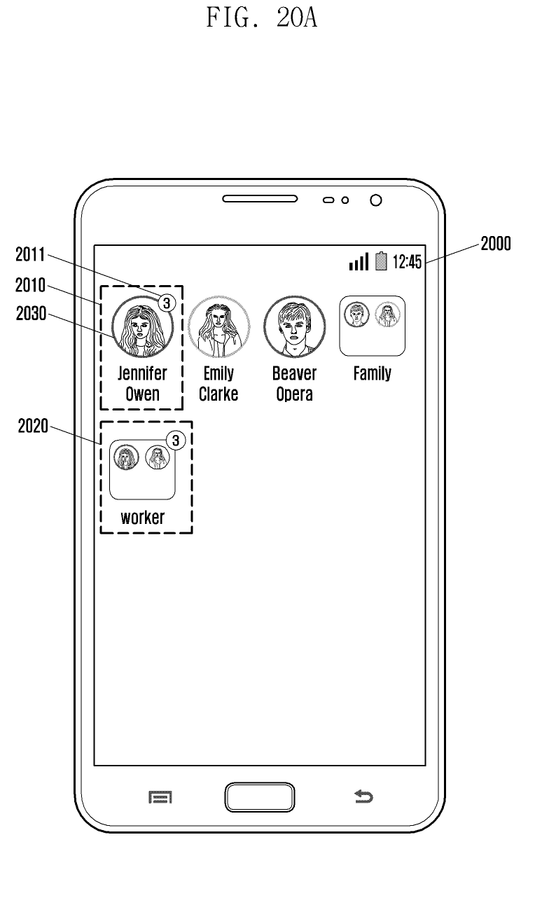

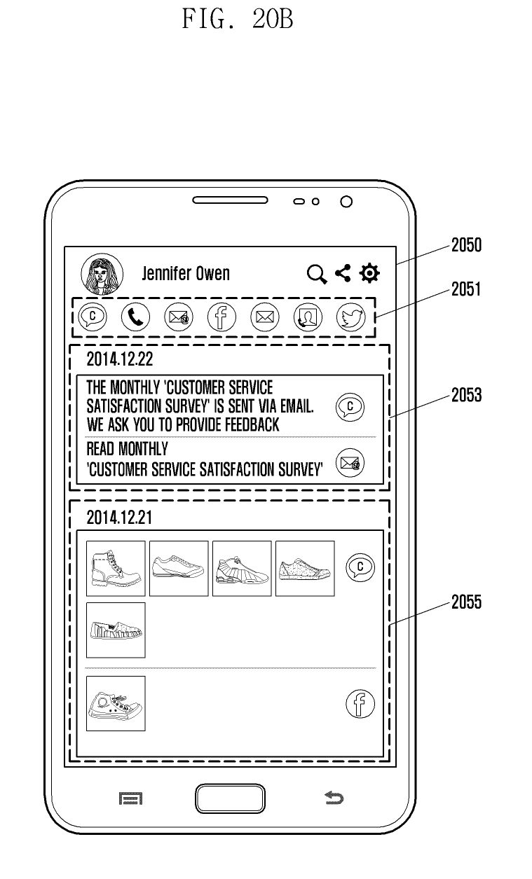

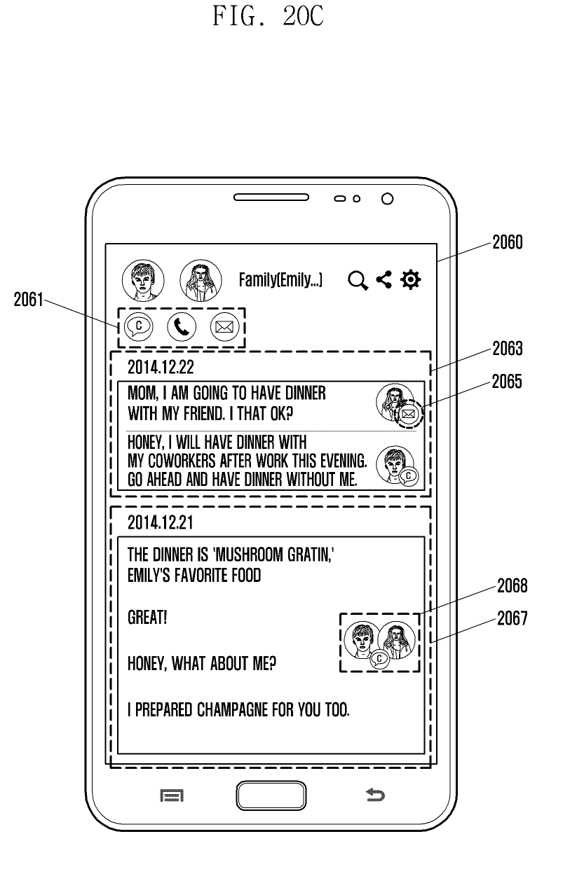

FIG. 20A is a diagram that describes a method of creating icons and folders, based on senders, on the home screen according to an embodiment of the present disclosure.

With reference to FIG. 20A, the processor 510 of the electronic device 500 is capable of creating application icons and folders based on senders stored in the contacts. For example, the processor 510 is capable of creating a profile image of a sender Jennifer Owen in the form of application icon on the screen 2000. In the following description, the application icon created from a profile image of a sender is referred to as a ‘sender icon’ 2010. The folder created from a profile image of a sender is referred to as a ‘sender folder’ 2020. The processor 510 is capable of adding the sender's name below the created profile image of the sender. When the electronic device 500 receives notification events from the sender Jennifer Owen, the processor 510 is capable of displaying the number of notifications 2011 above the profile image of the sender.

The processor 510 is capable of displaying the sender icon whose edge 2030 is displayed in different color from those of the other sender icons, so that the user can intuitively recognize an application corresponding to the latest received notification event. For example, when the latest received notification event is a notification event corresponding to a telephone application, the processor 510 is capable of displaying the sender icon whose edge 2030 is in green. When the latest received notification event is a notification event corresponding to a text application, the processor 510 is capable of displaying the sender icon whose edge 2030 is white. In a state where the edge 2030 of a sender icon is displayed in color, when the processor 510 receives a specified input from the user of the electronic device, it is capable of changing the screen into the communication application screen corresponding to the color of the edge 2030, according to the specified input. The specified input may be a preset input. For example, the specified input may be a ‘long tap,’ a ‘double tap,’ a ‘swipe left,’ and a ‘swipe right’, but inputs according to embodiments of the present disclosure are not limited thereto. When the specified input is set to a ‘long tap,’ the processor 510 is capable of detecting a ‘long tap’ applied to a sender icon 2010 whose edge 2030 is displayed in color. When a ‘long tap’ is applied to the sender icon 2010, the processor 510 is capable of changing the screen into the communication application screen corresponding to the color of the edge 2030, according to the specified input. That is, the processor 510 is capable of immediately switching the screen into a window to chat with the sender, based on a communication application corresponding to the color of the edge 2030. Alternatively, the processor 510 is capable of creating a number of sender icons into a folder. In this case, one folder may refer to one group chat room. For example, when the electronic device receives a notification event for a group chat room, the processor 510 is capable of creating the group chat room as a folder, and including senders participating in the group chat room in the created folder 2020.

FIG. 20B is a diagram that illustrates a method of displaying notifications based on individuals when a sender icon is selected on the home screen according to an embodiment of the present disclosure.

With reference to FIG. 20B, when the processor 510 ascertains that the sender icon is selected as shown in FIG. 20A, the processor 510 is capable of displaying notification event information related to the sender on the screen 2050. The processor 510 is capable of displaying a sender's profile image, a sender's name and applications 2051 available for communication with the sender on the screen 2050. The processor 510 is capable of displaying notification events from the sender on the screen 2050. For example, the processor 510 is capable of displaying notification events 2053 and 2055 from the sender in order of time.

FIG. 20C is a diagram that illustrates a method of displaying notifications based on groups when a sender folder is selected on the home screen according to an embodiment of the present disclosure.

With reference to FIG. 20C, when the processor 510 ascertains that the sender folder is selected as shown in FIG. 20A, the processor 510 is capable of displaying notification event information related to the group (e.g., a chat room) corresponding to the folder on the screen 2060. The processor 510 is capable of displaying senders' profile images in the group, a group name, and applications 2061 available for communication with the senders in the group on the screen 2060. The processor 510 is capable of displaying notification events 2063 and 2067 related to senders in the group. For example, the processor 510 is capable of displaying notification events received in order of time, profile images of the senders corresponding to the received notification events and application icons 2065 in the area 2063. When the electronic device receives a notification event based on an application with a created chat room, the processor 510 is capable of displaying profile images of senders included in the chat room 2068.

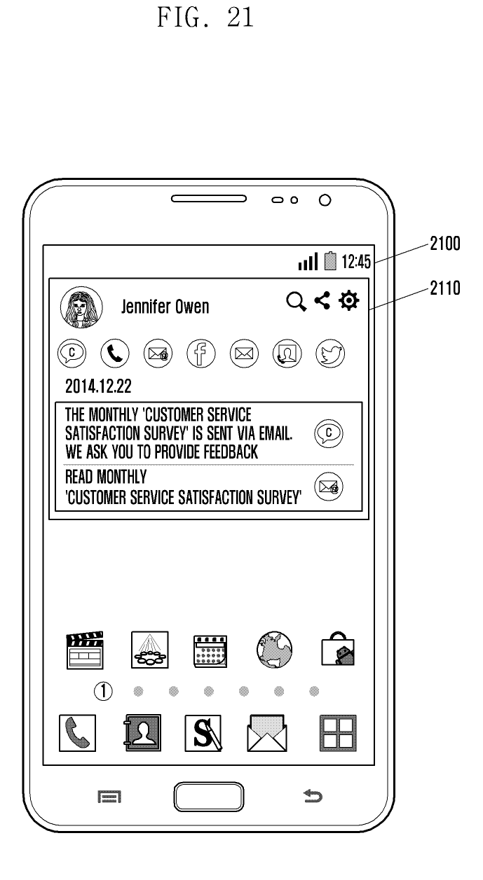

FIG. 21 is a diagram that illustrates a method of displaying notifications via a widget according to an embodiment of the present disclosure.

With reference to FIG. 21, the processor 510 of the electronic device 500 is capable of displaying a widget window 2110 on the screen 2100. According to an embodiment of the present disclosure notification events may be displayed using a widget application program.

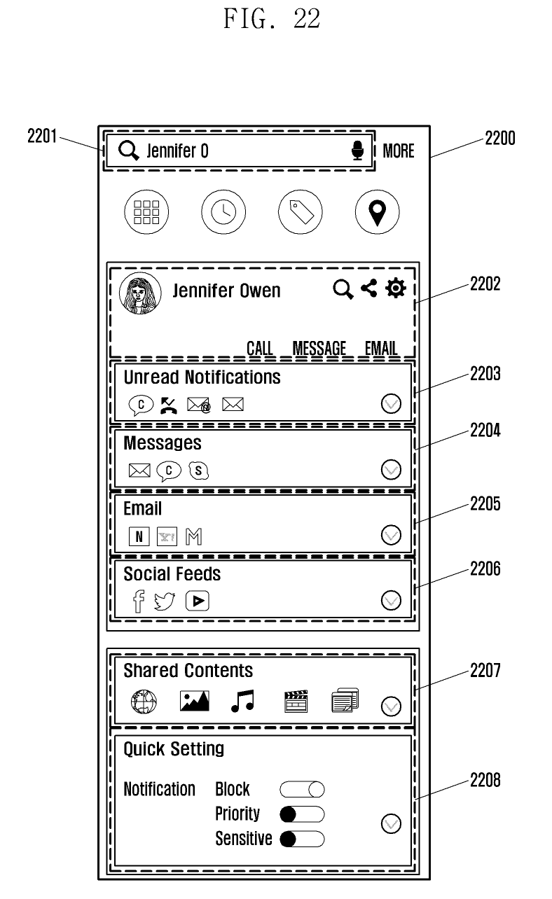

FIG. 22 is a diagram that illustrates a method of displaying, when searching for a sender, the view settings and notifications based on the sender according to an embodiment of the present disclosure.

Referring to FIG. 22, the processor 510 of the electronic device 500 is capable of searching for a sender Jennifer Owen via a search field 2201 and displaying various search results related to the sender. For example, the processor 510 is capable of displaying a searched sender's profile image and name 2202 on a screen 2200. The processor 510 is capable of integrally displaying unread notification events 2203 received from the searched sender. The processor 510 is capable of displaying information related to messages 2204 and e-mails 2205 received from the sender. The processor 510 is capable of displaying information that the sender posted via communication applications on the area 2206 on the screen. The processor 510 is capable of integrally displaying contents that the user has shared with the sender in the area 2207 on the screen. The processor 510 is capable of displaying a setup window for setting view settings for the sender in the area 2208 on the screen.

According to an embodiment of the present disclosure, a method of displaying notifications is implemented includes receiving at least one communication event or message from at least one external device; obtaining identification information which is stored in a memory or is obtained from at least one external device or at least one of the other external devices; identifying a user who sent the received, at least one communication event or message, by using the obtained identification information; creating or extracting notice information, based on at least part of the received, at least one communication event or message; linking the notice information to the identified user; and display and overlaying a notice, grouping information regarding the identified user and the notice information, on other objects displayed on the screen of the display.

According to an embodiment of the present disclosure, when identification information is not stored in the memory or cannot not be obtained from at least one external device or at least one of the other external devices, the notification method further includes creating identification information corresponding to the received, at least one communication event or message; and identifying a user who corresponds to the created identification information and sent at least one communication event or message.

According to an embodiment of the present disclosure, the notification method further includes transmitting the created identification information to at least one external device or at least one of the other external devices.

According to an embodiment of the present disclosure, the notification method further includes checking view settings corresponding to the identified user; and displaying and overlaying, based on the view settings, the grouped notice on other objects displayed on the screen of the display.

According to an embodiment of the present disclosure, the notification method further includes one of blocking the identified user; not displaying the grouped notice; displaying the grouped notice; and displaying content contained in the grouped notice.

According to an embodiment of the present disclosure, the method of displaying notifications and the electronic device adapted thereto are capable of providing notification services according to senders, thereby increasing user convenience.

At least part of the method (e.g., operations) or system (e.g., modules or functions) according to embodiments of the present disclosure can be implemented with instructions as programming modules that are stored in computer-readable storage media. One or more processors (e.g., the processor 120) can execute instructions, thereby performing the functions. An example of the computer-readable storage media may be the memory. At least part of the programming modules can be implemented (executed) by the processor. At least part of the programing module may include modules, programs, routines, sets of instructions or processes, etc., in order to perform one or more functions.

At least part of the method (e.g., operations) or system (e.g., modules or functions) according to embodiments of the present disclosure can be implemented with instructions as programming modules that are stored in computer-readable storage media. One or more processors (e.g., processor 120) can execute instructions, thereby performing the functions. An example of the computer-readable storage media may be a memory 130. At least part of the programming modules can be implemented (e.g., executed) by a processor. At least part of the programing module may include modules, programs, routines, sets of instructions or processes, etc., in order to perform one or more functions.

Examples of computer-readable media include: magnetic media, such as hard disks, floppy disks, and magnetic tape; optical media such as compact disc read only memory (CD-ROM) disks and digital versatile disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to embodiments of the present disclosure may include one or more components, remove part of them described above, or include new components. The operations performed by modules, programming modules, or the other components may be executed in serial, parallel, repetitive or heuristic fashion. Some of the operations can be executed in any other order, skipped, or executed with additional operations.

The embodiments of the present disclosure described herein and the accompanying drawings are merely provided to assist in a comprehensive understanding of the disclosure and do not limit embodiments of the present disclosure. Although embodiments of the disclosure have been described in detail above, it should be understood that many variations and modifications of the embodiments described herein, which may be apparent to those skilled in the art, will still fall within the spirit and scope of the embodiments of the disclosure as defined in the appended claims and their equivalents.

What is claimed is:

1. An electronic device comprising:
a communication circuit;
a display;
a processor electrically connected to the communication circuit and the display; and
a memory,
wherein the memory stores instructions enabling the processor to:
receive at least one communication event or message from at least one external device, via the communication circuit;
identify a user who sent the received at least one communication event or message, by using identification information which is stored in the memory or is obtained from the at least one external device or at least one other external device;
create or extract notice information, based on at least part of the received, at least one communication event or message;
link the notice information to the identified user; and
display and overlay a notice, grouping information regarding the identified user, and the notice information, on other objects displayed on a screen of the display.

2. The electronic device of claim 1, wherein, when identification information is not stored in the memory or cannot be obtained from the at least one external device or the at least one other external device, the instructions further enable the processor to:
create identification information corresponding to the received at least one communication event or message; and
identify a user who corresponds to the created identification information and sent at least one communication event or message.

3. The electronic device of claim 2, wherein the instructions further enable the processor to transmit the created identification information to the at least one external device or the at least one other external device.

4. The electronic device of claim 1, wherein the instructions further enable the processor to:
check view settings corresponding to the identified user; and
display and overlay, based on the checked view settings, the grouped notice on other objects displayed on the screen of the display.

5. The electronic device of claim 4, wherein, the instructions further enable the processor to perform, based on the view settings, at least one of:
blocking the identified user;
refraining from displaying the grouped notice;
displaying the grouped notice; and
displaying content contained in the grouped notice.

6. The electronic device of claim 4, wherein the view settings comprise:
settings set up according to the identified user.

7. The electronic device of claim 4, wherein the view settings comprise:
information regarding states of a user of the electronic device.

8. The electronic device of claim 1, wherein the notice comprises:
text or an image corresponding to the identified user.

9. The electronic device of claim 1, wherein the notice comprises:
at least a part of content contained in the received at least one message or communication event; or
a quantity of the received at least one message or communication event.

10. The electronic device of claim 1, wherein the identification information comprises at least one of an e-mail address, a phone number, a name, and a nickname.

11. A method of displaying notifications comprising:
receiving at least one communication event and message from at least one external device;
obtaining identification information which is stored in a memory or is obtained from the at least one external device or at least one other external device;
identifying a user who sent the received at least one communication event or message, by using the obtained identification information;
creating or extracting notice information, based on at least part of the received, at least one communication event or message;
linking the notice information to the identified user; and
displaying and overlaying a notice, grouping information regarding the identified user, and the notice information, on other objects displayed on a screen of a display.

12. The method of claim 11, further comprising:
creating, when identification information is not stored in the memory or cannot not be obtained from the at least one external device or the at least one other external devices, identification information corresponding to the received at least one communication event or message; and
identifying a user who corresponds to the created identification information and sent at least one communication event or message.

13. The method of claim 12, further comprising:
transmitting the created identification information to the at least one external device or the at least one other external device.

14. The method of claim 11, wherein displaying and overlaying a notice on other objects displayed on the screen of the display comprises:
checking view settings corresponding to the identified user; and
displaying and overlaying, based on the view settings, the grouped notice on other objects displayed on the screen of the display.

15. The method of claim 14, wherein displaying and overlaying the grouped notice comprises at least one of:
blocking the identified user;
refraining from displaying the grouped notice;
displaying the grouped notice; and
displaying content contained in the grouped notice.

16. The method of claim 14, wherein the view settings comprise:
settings set up according to the identified user.

17. The method of claim 14, wherein the view settings comprises:
information regarding states of a user of the electronic device.

18. The method of claim 11, wherein the notice comprises:
text or an image corresponding to the identified user.

19. The method of claim 11, wherein the notice comprises:
at least a part of content contained in the received at least one message or communication event; or a quantity of the received at least one message or communication event.

20. The method of claim 11, wherein the identification information comprises at least one of
an e-mail address, a phone number, a name, and a nickname.
